(19) United States
(12) Patent Application Publication
(10) Pub. No.: US 2026/0230994 A1
(43) Pub. Date: Aug. 6, 2026

(54) METHOD AND APPARATUS FOR EBI AND ARP MAPPING UPDATE

(71) Applicant: Telefonaktiebolaget LM Ericsson (publ), Stockholm (SE)

(72) Inventors: Wen ZHANG, Shanghai (CN); Yunjie LU, Shanghai (CN); Chunmiao LIU, Shanghai (CN); Yingjiao HE, Shanghai (CN); Jian TONG, Shanghai (CN)

(21) Appl. No.: 19/151,379

(22) PCT Filed: Dec. 27, 2023
(86) PCT No.: PCT/CN2023/142235

§ 371 Date: Jul. 28, 2025

(30) Foreign Application Priority Data
Jan. 31, 2023 (WO) PCT/CN2023/074027

(51) Int. Cl. H04W 40/24; H04W 28/02; H04W 76/18

(52) U.S. Cl. CPC H04W 40/246; H04W 28/0268; H04W 76/18

(57) ABSTRACT

A method and apparatus for EBI and ARP mapping update. A method performed by a first network function (NF) service consumer includes receiving a first request comprising modified EBI list IE indicating one or more updated EBI and allocation and retention priority (ARP) mapping from a second NF service consumer. The method further includes sending a first response to the second NF service consumer. When the first NF service consumer and/or the NF service producer does not support EBI and ARP mapping update in EBI assignment and/or the NF service producer cannot update the mapping of EBI and ARP, the first response includes first information indicating one or more explanations.

### TECHNICAL FIELD

The non-limiting and exemplary embodiments of the present disclosure generally relate to the technical field of communications, and specifically to methods and apparatuses for evolved packet system bearer identity (EBI) and allocation and retention priority (ARP) mapping update.

### BACKGROUND

This section introduces aspects that may facilitate a better understanding of the disclosure. Accordingly, the statements of this section are to be read in this light and are not to be understood as admissions about what is in the prior art or what is not in the prior art.

In communication networks, there may be various sessions such as protocol data unit (PDU) sessions. For example, a user equipment (UE) may initiate a PDU session establishment procedure. A UE may initiate PDU session handover between 3GPP (Third Generation Partnership Project) network and non-3GPP network. A UE may initiate PDU session handover from Evolved Packet System (EPS) to 5GS (fifth generation system). A network may trigger a PDU session establishment procedure. PDU session modification procedure may be used when one or several of the quality of service (QoS) parameters exchanged between the UE and the network are modified.

3GPP TS 29.518 V18.0.0, the disclosure of which is incorporated by reference herein in its entirety, has specified EAEA feature, which allows a network function (NF) Service Consumer, e.g. a session management function (SMF), towards a NF Service Producer supporting the EAEA feature, i.e. the Access and Mobility Management Function (AMF), to request the AMF to update the mapping of EBI (EPS Bearer Identity) and Allocation and Retention Priority (ARP), if the ARP for a QoS flow that has already been allocated an EBI is changed during the network requested PDU Session Modification. The SMF may provide the modifiedEbiList when the EAEA feature is supported by both AMF and SMF.

If the request contains “modifiedEbiList”, the AMF may store the association of the assigned EBI and ARP pair to the corresponding PDU Session ID (identifier). The AMF may respond with the status code 200 OK and may include the EBI(s) with ARP updated in the “modifiedEbiList” IE of the POST response body.

Table 1 shows the EAEA feature used by Namf_Communication service, which is a copy of Table 6.1.8-1 of 3GPP TS 29.518 V18.0.0.

TABLE 1

| Feature | | | |
|---|---|---|---|
| Number | Feature | M/O | Description |
| 8 | EAEA | O | EBI and ARP mapping update in EBIAssignment |
| | | | Support of this feature implies support of updating the mapping of EBI and ARP in |
| | | | EBIAssignment for a QoS flow to which an EBI is already allocated. |

Feature number: The order number of the feature within the supportedFeatures attribute (starting with 1).
Feature: A short name that can be used to refer to the bit and to the feature.
M/O: Defines if the implementation of the feature is mandatory (“M”) or optional (“O”).
Description: A clear textual description of the feature.

Table 2 shows a definition of type AssignEbiData, which is a copy of Table 6.1.6.2.5-1 of 3GPP TS 29.518 V18.0.0.

TABLE 2

| | | | Cardi- | | Applica- |
|---|---|---|---|---|---|
| Attribute name | Data type | P | nality | Description | bility |
| pduSessionId | PduSessionId | M | 1 | Represents the identifier of the PDU Session | |
| | | | | requesting EBI(s) to be assigned. | |
| arpList | array(Arp) | C | 1 . . . N | This IE shall be present if the NF Service | |
| | | | | Consumer (e.g SMF) requests the AMF to | |
| | | | | assign EBI(s) for the PDU session. When | |
| | | | | present, this IE shall contain the list of | |
| | | | | ARP(s)of the QoS flow(s) for which EBI(s) | |
| | | | | are requested. | |
| releasedEbiList | array(EpsBearerId) | C | 1 . . . N | This IE shall be present if the NF Service | |
| | | | | Consumer (e.g. SMF) needs to release the | |
| | | | | assigned EBI(s) from QoS flows (e.g. when | |
| | | | | the QoS flow is released). | |
| oldGuami | Guami | C | 0 . . . 1 | This IE shall be present during an AMF | |
| | | | | planned removal procedure when the NF | |
| | | | | Service Consumer initiates a request towards | |
| | | | | the target AMF, for a UE associated to an | |
| | | | | AMF that is unavailable (see clause 5.21.2.2 | |
| | | | | of 3GPP TS 23.501 [2]). | |
| modifiedEbiList | array(EbiArpMapping) | C | 1 . . . N | This IE shall be present if a PDU session | EAEA |
| | | | | modification procedure resulted in the | |
| | | | | change of ARP for a QoS flow to which an | |
| | | | | EBI is already allocated. | |

Clause 5.2.2.8.3.2 of 3GPP TS 29.502 V18.1.0, the disclosure of which is incorporated by reference herein in its entirety, described network (e.g. H-SMF (home SMF), SMF) requested PDU session modification. The NF Service Consumer may include the modifiedEbiList IE (information element) if the PDU session modification procedure resulted in the change of ARP for a QoS flow that has already been allocated an EBI.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

3GPP TS 29.502 V18.1.0 has defined for SMF and AMF how to support EAEA feature, but it is not clearly defined how to support EAEA feature with I-SMF (intermediate SMF)/V-SMF (visited SMF).

In 3GPP TS 29.502 V18.1.0, during the network requested PDU session modification, e.g. to update the APR of the QoS flow, SMF/H-SMF may include the EbiArpMapping in VsmfUpdateData IE to I-SMF/V-SMF. The I-SMF/V-SMF may send the EbiArpMapping to AMF. However, if the AMF doesn't support EAEA, the SMF/H-SMF cannot provide the modified EBI ARP mapping list to AMF via EBIAssignment operation as required. A way is to provide the modified APR of the QoS flow in an SM (session management) Context Update response if the EAEA feature is not supported by the AMF.

During I-SMF/V-SMF insert, SMF/H-SMF cannot get the clear information whether the AMF supports EAEA or not. And if SMF/H-SMF triggers to send modifiedEbiList to AMF, the SMF/H-SMF cannot get the information whether the modifiedEbiList is handled by AMF or not.

Therefore 3GPP TS 29.502 V18.1.0 provides an incomplete solution on I-SMF/SMF handling the modified EBI/ARP mapping. The incomplete solution may cause inconsistence between SMF (H-SMF) and AMF and lead to incorrect EBI assignment failure or revocation when EBIs are used out for a UE.

An option may be that the I-SMF/V-SMF caches the pending modified EBI/ARP mapping list and will provide to the AMF in a future SM Context Update response. However this option requires that the I-SMF/V-SMF will need to locally store the modified EBI/ARP list until next UE (user equipment)/RAN (radio access network) triggered PDU session modification in unpredictable future and to exchange the stored information between I-SMFs/V-SMFs if the I-SMF/V-SMF is changed during UE mobility. It also requires that I-SMF/V-SMF to merge multiple modified EBI/ARP mapping lists if subsequent modified EBI/ARP mapping lists are received from SMF/H-SMF before the I-SMF/V-SMF can deliver the modified EBI/ARP lists to AMF. Another disadvantage is the misalignment between SMF/H-SMF and AMF because the SMF/H-SMF will always consider that the AMF is updated, while the I-SMF/V-SMF acting as a relay for EBI activities keeps the intermediate delta which is not intended.

In addition, EAEA is only defined in Namf_Communication service. It has a problem. For example, when a PDU session moves from a fourth generation (4G) network to a fifth generation (5G) network, Namf_Communication service is not used and AMF cannot negotiate with SMF with EAEA feature.

To overcome or mitigate at least one of above mentioned problems or other problems, the embodiments of the present disclosure propose an improved solution for EBI and ARP mapping update.

In an embodiment, the I-SMF/V-SMF indicates in a Vsmf Update Response to the SMF that the modified EBI/ARP mapping list is not delivered to AMF, which means that the SMF/H-SMF may perform any suitable operation for example based on a policy, e.g., the SMF/H-SMF may retry later.

In an embodiment, the I-SMF/V-SMF indicates the failed delivery of modified EBI list via N16a to SMF.

In an embodiment, the I-SMF/V-SMF may send a new indication in VsmfUpdatedData indicating the failure delivery of modified EBI/ARP mapping list to SMF/H-SMF.

In an embodiment, V-SMF/I-SMF may update to AMF about EBI/ARP mapping when EAEA is supported by AMF. Otherwise the failed delivery is indicated in the VsmfUpdatedData to the SMF/H-SMF.

In an embodiment, I-SMF/V-SMF may send indicating information to SMF/H-SMF that modifiedEbiList is not successfully handled by AMF.

In an embodiment, EAEA can be negotiated with AMF and SMF/H-SMF through I-SMF/V-SMF in SMContext Service.

In a first aspect of the disclosure, there is provided a method performed by a first network function (NF) service consumer. The method comprises receiving a first request comprising modified evolved packet system bearer identity (EBI) list information element indicating one or more updated EBI and allocation and retention priority (ARP) mapping from a second NF service consumer. The method further comprises sending a first response to the second NF service consumer. When the first NF service consumer and/or the NF service producer does not support EBI and ARP mapping update in EBI assignment and/or the NF service producer cannot update the mapping of EBI and ARP, the first response comprises first information indicating at least one of failure information, error information, the NF service producer cannot update the mapping of EBI and ARP, the modified EBI list information element is not delivered to the NF service producer, the modified EBI list information element is not updated to the NF service producer, the modified EBI list information element is not successfully handled by the NF service producer, or the first NF service consumer and/or the NF service producer does not support EBI and ARP mapping update in EBI assignment.

In an embodiment, the first request is a protocol data unit (PDU) session update request and the first response is a PDU session update response.

In an embodiment, the first information is comprised in visited session management function (SMF) updated data.

In an embodiment, a data type of the first information is Boolean and the first information is set as true.

In an embodiment, the method further comprises, when both the first NF service consumer and the NF service producer support EBI and ARP mapping update in EBI assignment, sending a second request comprising the modified EBI list information element to the NF service producer. The second request requests the NF service producer to update the mapping of EBI and ARP.

In an embodiment, when both the first NF service consumer and the NF service producer support EBI and ARP mapping update in EBI assignment and/or the NF service producer has updated the mapping of EBI and ARP, the first response comprises second information indicating at least one of successful information, the NF service producer has updated the mapping of EBI and ARP, the modified EBI list information element is delivered to the NF service producer, the modified EBI list information element is updated to the NF service producer, the modified EBI list information element is successfully handled by the NF service producer, or the first NF service consumer and the NF service producer support EBI and ARP mapping update in EBI assignment.

In an embodiment, the second information is comprised in visited SMF updated data.

In an embodiment, a data type of the second information is Boolean and the second information is set as false.

In an embodiment, the second request is an EBI assignment request.

In an embodiment, the first NF service consumer comprises at least one of an intermediate SMF or a visited SMF.

In an embodiment, the second NF service consumer comprises at least one of an SMF, a Packet Data Network Gateway control plane (PGW-C) combined with SMF, or a home SMF.

In an embodiment, the NF service producer comprises an access and mobility management function (AMF).

In an embodiment, the method further comprises, during fourth generation system to fifth generation system mobility procedure, sending a message comprising information indicating whether the first NF service consumer supports EBI and ARP mapping update in EBI assignment to the second NF service consumer and/or the NF service producer.

In an embodiment, the method further comprises, during fourth generation system to fifth generation system mobility procedure, receiving a message comprising information indicating whether the second NF service consumer and/or the NF service producer supports EBI and ARP mapping update in EBI assignment from the second NF service consumer and/or the NF service producer.

In a second aspect of the disclosure, there is provided a method performed by a second NF service consumer. The method comprises sending a first request comprising modified evolved packet system bearer identity (EBI) list information element indicating one or more updated EBI and allocation and retention priority (ARP) mapping to a first NF service consumer. The method further comprises receiving a first response from the first NF service consumer. When the first NF service consumer and/or the NF service producer does not support EBI and ARP mapping update in EBI assignment and/or the NF service producer cannot update the mapping of EBI and ARP, the first response comprises first information indicating at least one of failure information, error information, the NF service producer cannot update the mapping of EBI and ARP, the modified EBI list information element is not delivered to the NF service producer, the modified EBI list information element is not updated to the NF service producer, the modified EBI list information element is not successfully handled by the NF service producer, or the first NF service consumer and/or the NF service producer does not support EBI and ARP mapping update in EBI assignment.

In an embodiment, the first request is a PDU session update request and the first response is a PDU session update response.

In an embodiment, the first information is comprised in visited SMF updated data.

In an embodiment, a data type of the first information is Boolean and the first information is set as true.

In an embodiment, when both the first NF service consumer and the NF service producer support EBI and ARP mapping update in EBI assignment and/or the NF service producer has updated the mapping of EBI and ARP, the first response comprises second information indicating at least one of successful information, the NF service producer has updated the mapping of EBI and ARP, the modified EBI list information element is delivered to the NF service producer, the modified EBI list information element is updated to the NF service producer, the modified EBI list information element is successfully handled by the NF service producer, or the first NF service consumer and the NF service producer support EBI and ARP mapping update in EBI assignment.

In an embodiment, the second information is comprised in visited SMF updated data.

In an embodiment, a data type of the second information is Boolean and the second information is set as false.

In an embodiment, the first NF service consumer comprises at least one of an intermediate SMF or a visited SMF.

In an embodiment, the second NF service consumer comprises at least one of an SMF, a Packet Data Network Gateway control plane (PGW-C) combined with SMF, or a home SMF.

In an embodiment, the NF service producer comprises an access and mobility management function (AMF).

In an embodiment, the first request is sent to the first NF service consumer when an ARP for a quality of service (QoS) flow that has already been allocated an EBI is changed.

In an embodiment, the second NF service consumer does not know whether the first NF service consumer and/or the NF service producer supports EBI and ARP mapping update in EBI assignment.

In an embodiment, the method further comprises, during fourth generation system to fifth generation system mobility procedure, sending a message comprising information indicating whether the second NF service consumer supports EBI and ARP mapping update in EBI assignment to the first NF service consumer and/or the NF service producer.

In an embodiment, the method further comprises, during fourth generation system to fifth generation system mobility procedure, receiving a message comprising information indicating whether the first NF service consumer and/or the NF service producer supports EBI and ARP mapping update in EBI assignment from the first NF service consumer and/or the NF service producer.

In a third aspect of the disclosure, there is provided a method performed by a third NF service consumer. The method comprises receiving a first message from an NF service producer. The first message comprises information indicating whether the NF service producer supports evolved packet system bearer identity (EBI) and allocation and retention priority (ARP) mapping update in EBI assignment. The method further comprises sending a second message to a fourth NF service consumer. The second message comprises information indicating whether the NF service producer and/or the third NF service consumer supports EBI and ARP mapping update in EBI assignment.

In an embodiment, the first message is a protocol data unit (PDU) session create session management context request and the second message is a PDU session create request.

In an embodiment, the first message is received from the NF service producer and the second message is sent to the fourth NF service consumer during a PDU session establishment procedure.

In an embodiment, the method further comprises receiving a third message from the fourth NF service consumer. The third message comprises information indicating whether the fourth NF service consumer supports EBI and ARP mapping update in EBI assignment.

In an embodiment, the method further comprises sending a fourth message to the NF service producer. The fourth message comprises information indicating whether the fourth NF service consumer and/or the third NF service consumer supports EBI and ARP mapping update in EBI assignment.

In an embodiment, the third message is a PDU session create response and the fourth message is an Namf_Communication_N1N2MessageTransfer message.

In an embodiment, the third message is received from the fourth NF service consumer and the fourth message is sent to the NF service producer during a PDU session establishment procedure.

In an embodiment, the third NF service consumer comprises at least one of an intermediate SMF or a visited SMF.

In an embodiment, the fourth NF service consumer comprises at least one of an SMF, a Packet Data Network Gateway control plane (PGW-C) combined with SMF, or a home SMF.

In an embodiment, the NF service producer comprises an access and mobility management function (AMF).

In an embodiment, the method further comprises during fourth generation system to fifth generation system mobility procedure, sending a message comprising information indicating whether the third NF service consumer supports EBI and ARP mapping update in EBI assignment to the fourth NF service consumer and/or the NF service producer.

In an embodiment, the method further comprises during fourth generation system to fifth generation system mobility procedure, receiving a message comprising information indicating whether the fourth NF service consumer and/or the NF service producer supports EBI and ARP mapping update in EBI assignment from the fourth NF service consumer and/or the NF service producer.

In a fourth aspect of the disclosure, there is provided a method performed by a fourth NF service consumer. The method comprises receiving a second message from a third NF service consumer. The second message comprises information indicating whether an NF service producer and/or the third NF service consumer supports evolved packet system bearer identity (EBI) and allocation and retention priority (ARP) mapping update in EBI assignment.

In an embodiment, the method further comprises determining whether to send a request comprising modified EBI list information element to the third NF service consumer based on the information. The request requests the NF service producer to update a mapping of EBI and ARP.

In an embodiment, the second message is a PDU session create request.

In an embodiment, the second message is received from the third NF service consumer during a PDU session establishment procedure.

In an embodiment, the method further comprises sending a third message to the third NF service consumer. The third message comprises information indicating whether the fourth NF service consumer supports EBI and ARP mapping update in EBI assignment.

In an embodiment, the third message is a PDU session create response.

In an embodiment, the third message is sent to the third NF service consumer during a PDU session establishment procedure.

In an embodiment, the third NF service consumer comprises at least one of an intermediate SMF, or a visited SMF.

In an embodiment, the fourth NF service consumer comprises at least one of an SMF, a Packet Data Network Gateway control plane (PGW-C) combined with SMF, or a home SMF.

In an embodiment, the NF service producer comprises an access and mobility management function (AMF).

In an embodiment, the method further comprises during fourth generation system to fifth generation system mobility procedure, sending a message comprising information indicating whether the fourth NF service consumer supports EBI and ARP mapping update in EBI assignment to the third NF service consumer and/or the NF service producer.

In an embodiment, the method further comprises during fourth generation system to fifth generation system mobility procedure, receiving a message comprising information indicating whether the third NF service consumer and/or the NF service producer supports EBI and ARP mapping update in EBI assignment from the third NF service consumer and/or the NF service producer.

In a fifth aspect of the disclosure, there is provided a method performed by a NF service producer. The method comprises sending a first message to a third NF service consumer. The first message comprises information indicating whether the NF service producer supports evolved packet system bearer identity (EBI) and allocation and retention priority (ARP) mapping update in EBI assignment. The information is to be sent to a fourth NF service consumer by the third NF service consumer.

In an embodiment, the first message is a protocol data unit (PDU) session create session management context request.

In an embodiment, the first message is sent to the third NF service consumer during a PDU session establishment procedure.

In an embodiment, the method further comprises receiving a fourth message from the third NF service consumer. The fourth message comprises information indicating whether the fourth NF service consumer and/or the third NF service consumer supports EBI and ARP mapping update in EBI assignment.

In an embodiment, the fourth message is an Namf_Communication_N1N2MessageTransfer message.

In an embodiment, the fourth message is received from the third NF service consumer during a PDU session establishment procedure.

In an embodiment, the third NF service consumer comprises at least one of an intermediate SMF, or a visited SMF.

In an embodiment, the fourth NF service consumer comprises at least one of an SMF, a Packet Data Network Gateway control plane (PGW-C) combined with SMF, or a home SMF.

In an embodiment, the NF service producer comprises an access and mobility management function (AMF).

In an embodiment, the method further comprises during fourth generation system to fifth generation system mobility procedure, sending a message comprising information indicating whether the NF service producer supports EBI and ARP mapping update in EBI assignment to the third NF service consumer and/or the fourth NF service consumer.

In an embodiment, the method further comprises during fourth generation system to fifth generation system mobility procedure, receiving a message comprising information indicating whether the third NF service consumer and/or the fourth NF service consumer supports EBI and ARP mapping update in EBI assignment from the third NF service consumer and/or the fourth NF service consumer.

In a sixth aspect of the disclosure, there is provided a first NF service consumer. The first NF service consumer comprises a processor and a memory coupled to the processor. Said memory contains instructions executable by said processor. Said first NF service consumer is operative to receive a first request comprising modified evolved packet system bearer identity (EBI) list information element indicating one or more updated EBI and allocation and retention priority (ARP) mapping from a second NF service consumer. Said first NF service consumer is further operative to send a first response to the second NF service consumer. When the first NF service consumer and/or the NF service producer does not support EBI and ARP mapping update in EBI assignment and/or the NF service producer cannot update the mapping of EBI and ARP, the first response comprises first information indicating at least one of failure information, error information, the NF service producer cannot update the mapping of EBI and ARP, the modified EBI list information element is not delivered to the NF service producer, the modified EBI list information element is not updated to the NF service producer, the modified EBI list information element is not successfully handled by the NF service producer, or the first NF service consumer and/or the NF service producer does not support EBI and ARP mapping update in EBI assignment.

In a seventh aspect of the disclosure, there is provided a second NF service consumer. The second NF service consumer comprises a processor and a memory coupled to the processor. Said memory contains instructions executable by said processor. Said second NF service consumer is operative to send a first request comprising modified evolved packet system bearer identity (EBI) list information element indicating one or more updated EBI and allocation and retention priority (ARP) mapping to a first NF service consumer. Said second NF service consumer is further operative to receive a first response from the first NF service consumer. When the first NF service consumer and/or the NF service producer does not support EBI and ARP mapping update in EBI assignment and/or the NF service producer cannot update the mapping of EBI and ARP, the first response comprises first information indicating at least one of failure information, error information, the NF service producer cannot update the mapping of EBI and ARP, the modified EBI list information element is not delivered to the NF service producer, the modified EBI list information element is not updated to the NF service producer, the modified EBI list information element is not successfully handled by the NF service producer, or the first NF service consumer and/or the NF service producer does not support EBI and ARP mapping update in EBI assignment.

In an eighth aspect of the disclosure, there is provided a third NF service consumer. The third NF service consumer comprises a processor and a memory coupled to the processor. Said memory contains instructions executable by said processor. Said third NF service consumer is operative to receive a first message from an NF service producer. The first message comprises information indicating whether the NF service producer supports evolved packet system bearer identity (EBI) and allocation and retention priority (ARP) mapping update in EBI assignment. Said third NF service consumer is operative to send a second message to a fourth NF service consumer. The second message comprises information indicating whether the NF service producer and/or the third NF service consumer supports EBI and ARP mapping update in EBI assignment.

In a ninth aspect of the disclosure, there is provided a fourth NF service consumer. The fourth NF service consumer comprises a processor and a memory coupled to the processor. Said memory contains instructions executable by said processor. Said fourth NF service consumer is operative to receive a second message from a third NF service consumer. The second message comprises information indicating whether an NF service producer and/or the third NF service consumer supports evolved packet system bearer identity (EBI) and allocation and retention priority (ARP) mapping update in EBI assignment.

In a tenth aspect of the disclosure, there is provided a NF service producer. The NF service producer comprises a processor and a memory coupled to the processor. Said memory contains instructions executable by said processor. Said NF service producer is operative to send a first message to a third NF service consumer. The first message comprises information indicating whether the NF service producer supports evolved packet system bearer identity (EBI) and allocation and retention priority (ARP) mapping update in EBI assignment. The information is to be sent to a fourth NF service consumer by the third NF service consumer.

In an eleventh aspect of the disclosure, there is provided a first NF service consumer. The first NF service consumer comprises a first receiving module configured to receive a first request comprising modified evolved packet system bearer identity (EBI) list information element indicating one or more updated EBI and allocation and retention priority (ARP) mapping from a second NF service consumer. The first NF service consumer further comprises a first sending module configured to send a first response to the second NF service consumer. When the first NF service consumer and/or the NF service producer does not support EBI and ARP mapping update in EBI assignment and/or the NF service producer cannot update the mapping of EBI and ARP, the first response comprises first information indicating at least one of failure information, error information, the NF service producer cannot update the mapping of EBI and ARP, the modified EBI list information element is not delivered to the NF service producer, the modified EBI list information element is not updated to the NF service producer, the modified EBI list information element is not successfully handled by the NF service producer, or the first NF service consumer and/or the NF service producer does not support EBI and ARP mapping update in EBI assignment.

In an embodiment, the first NF service consumer further comprises a second sending module configured to, when both the first NF service consumer and the NF service producer support EBI and ARP mapping update in EBI assignment, send a second request comprising the modified EBI list information element to the NF service producer. The second request requests the NF service producer to update the mapping of EBI and ARP.

In an embodiment, the first NF service consumer further comprises a third sending module configured to, during fourth generation system to fifth generation system mobility procedure, send a message comprising information indicating whether the first NF service consumer supports EBI and ARP mapping update in EBI assignment to the second NF service consumer and/or the NF service producer.

In an embodiment, the first NF service consumer further comprises a second receiving module configured to, during fourth generation system to fifth generation system mobility procedure, receive a message comprising information indicating whether the second NF service consumer and/or the NF service producer supports EBI and ARP mapping update in EBI assignment from the second NF service consumer and/or the NF service producer.

In a twelfth aspect of the disclosure, there is provided a second NF service consumer. The second NF service consumer comprises a first sending module configured to send a first request comprising modified evolved packet system bearer identity (EBI) list information element indicating one or more updated EBI and allocation and retention priority (ARP) mapping to a first NF service consumer. The second NF service consumer further comprises a first receiving module configured to receiving a first response from the first NF service consumer. When the first NF service consumer and/or the NF service producer does not support EBI and ARP mapping update in EBI assignment and/or the NF service producer cannot update the mapping of EBI and ARP, the first response comprises first information indicating at least one of failure information, error information, the NF service producer cannot update the mapping of EBI and ARP, the modified EBI list information element is not delivered to the NF service producer, the modified EBI list information element is not updated to the NF service producer, the modified EBI list information element is not successfully handled by the NF service producer, or the first NF service consumer and/or the NF service producer does not support EBI and ARP mapping update in EBI assignment.

In an embodiment, the second NF service consumer further comprises a second sending module configured to, during fourth generation system to fifth generation system mobility procedure, send a message comprising information indicating whether the second NF service consumer supports EBI and ARP mapping update in EBI assignment to the first NF service consumer and/or the NF service producer.

In an embodiment, the second NF service consumer further comprises a second receiving module configured to, during fourth generation system to fifth generation system mobility procedure, receive a message comprising information indicating whether the first NF service consumer and/or the NF service producer supports EBI and ARP mapping update in EBI assignment from the first NF service consumer and/or the NF service producer.

In a thirteenth aspect of the disclosure, there is provided a third NF service consumer. The third NF service consumer comprises a first receiving module configured to receive a first message from an NF service producer. The first message comprises information indicating whether the NF service producer supports evolved packet system bearer identity (EBI) and allocation and retention priority (ARP) mapping update in EBI assignment. The third NF service consumer further comprises a first sending module configured to send a second message to a fourth NF service consumer. The second message comprises information indicating whether the NF service producer and/or the third NF service consumer supports EBI and ARP mapping update in EBI assignment.

In an embodiment, the third NF service consumer further comprises a second receiving module configured to receive a third message from the fourth NF service consumer. The third message comprises information indicating whether the fourth NF service consumer supports EBI and ARP mapping update in EBI assignment.

In an embodiment, the third NF service consumer further comprises a second sending module configured to sending a fourth message to the NF service producer. The fourth message comprises information indicating whether the fourth NF service consumer and/or the third NF service consumer supports EBI and ARP mapping update in EBI assignment.

In an embodiment, the third NF service consumer further comprises a third sending module configured to, during fourth generation system to fifth generation system mobility procedure, send a message comprising information indicating whether the third NF service consumer supports EBI and ARP mapping update in EBI assignment to the fourth NF service consumer and/or the NF service producer.

In an embodiment, the third NF service consumer further comprises a third receiving module configured to, during fourth generation system to fifth generation system mobility procedure, receive a message comprising information indicating whether the fourth NF service consumer and/or the NF service producer supports EBI and ARP mapping update in EBI assignment from the fourth NF service consumer and/or the NF service producer.

In a fourteenth aspect of the disclosure, there is provided a fourth NF service consumer. The fourth NF service consumer comprises a first receiving module configured to receive a second message from a third NF service consumer. The second message comprises information indicating whether an NF service producer and/or the third NF service consumer supports evolved packet system bearer identity (EBI) and allocation and retention priority (ARP) mapping update in EBI assignment.

In an embodiment, the fourth NF service consumer further comprises a determining module configured to determine whether to send a request comprising modified EBI list information element to the third NF service consumer based on the information. The request requests the NF service producer to update a mapping of EBI and ARP.

In an embodiment, the fourth NF service consumer further comprises a first sending module configured to send a third message to the third NF service consumer. The third message comprises information indicating whether the fourth NF service consumer supports EBI and ARP mapping update in EBI assignment.

In an embodiment, the fourth NF service consumer further comprises a second sending module configured to, during fourth generation system to fifth generation system mobility procedure, send a message comprising information indicating whether the fourth NF service consumer supports EBI and ARP mapping update in EBI assignment to the third NF service consumer and/or the NF service producer.

In an embodiment, the fourth NF service consumer further comprises a second receiving module configured to, during fourth generation system to fifth generation system mobility procedure, receive a message comprising information indicating whether the third NF service consumer and/or the NF service producer supports EBI and ARP mapping update in EBI assignment from the third NF service consumer and/or the NF service producer.

In a fifteenth aspect of the disclosure, there is provided a NF service producer. The NF service producer comprises a first sending module configured to send a first message to a third NF service consumer. The first message comprises information indicating whether the NF service producer supports evolved packet system bearer identity (EBI) and allocation and retention priority (ARP) mapping update in EBI assignment. The information is to be sent to a fourth NF service consumer by the third NF service consumer.

In an embodiment, the NF service producer further comprises a first receiving module configured to receive a fourth message from the third NF service consumer. The fourth message comprises information indicating whether the fourth NF service consumer and/or the third NF service consumer supports EBI and ARP mapping update in EBI assignment.

In an embodiment, the NF service producer further comprises a second sending module configured to, during fourth generation system to fifth generation system mobility procedure, send a message comprising information indicating whether the NF service producer supports EBI and ARP mapping update in EBI assignment to the third NF service consumer and/or the fourth NF service consumer.

In an embodiment, the NF service producer further comprises a second receiving module configured to, during fourth generation system to fifth generation system mobility procedure, receive a message comprising information indicating whether the third NF service consumer and/or the fourth NF service consumer supports EBI and ARP mapping update in EBI assignment from the third NF service consumer and/or the fourth NF service consumer.

In another aspect of the disclosure, there is provided a computer program product comprising instructions which when executed by at least one processor, cause the at least one processor to perform the method according to any one of the first, second, third, fourth or fifth aspects.

In another aspect of the disclosure, there is provided a computer-readable storage medium storing instructions which when executed by at least one processor, cause the at least one processor to perform the method according to any one of the first, second, third, fourth or fifth aspects.

Embodiments herein may provide many advantages, of which a non-exhaustive list of examples follows. In some embodiments herein, I-SMF/V-SMF can notify A-SMF/H-SMF/PGW-C+SMF if the modifiedEbiList is successful handled by AMF or not. In some embodiments herein, I-SMF/V-SMF can notify A-SMF/H-SMF/PGW-C+SMF if EAEA feature is supported or not. In some embodiments herein, it may ensure the consistence or alignment between SMF/H-SMF/PGW-C+SMF and AMF because SMF H-SMF/PGW-C+SMF can know whether AMF is updated or not. In some embodiments herein, it may avoid incorrect EBI assignment failure or revocation when EBIs are used out for a UE. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 schematically shows 5G system roaming architecture in the case of home routed scenario using the reference point representation according to an embodiment of the present disclosure;

FIG. 2 schematically shows non-roaming architecture with I-SMF insertion to the PDU session in reference point representation, with no UL-CL/BP according to an embodiment of the present disclosure;

FIG. 3a shows a flowchart of a method according to an embodiment of the present disclosure;

FIG. 3b shows a flowchart of a method according to another embodiment of the present disclosure;

FIG. 3c shows a flowchart of a method according to another embodiment of the present disclosure;

FIG. 4a shows a flowchart of a method according to another embodiment of the present disclosure;

FIG. 4b shows a flowchart of a method according to another embodiment of the present disclosure;

FIG. 5a shows a flowchart of a method according to an embodiment of the present disclosure;

FIG. 5b shows a flowchart of a method according to another embodiment of the present disclosure;

FIG. 5c shows a flowchart of a method according to another embodiment of the present disclosure;

FIG. 6a shows a flowchart of a method according to an embodiment of the present disclosure;

FIG. 6b shows a flowchart of a method according to another embodiment of the present disclosure;

FIG. 6c shows a flowchart of a method according to another embodiment of the present disclosure;

FIG. 6d shows a flowchart of a method according to another embodiment of the present disclosure;

FIG. 7a shows a flowchart of a method according to an embodiment of the present disclosure;

FIG. 7b shows a flowchart of a method according to another embodiment of the present disclosure;

FIG. 7c shows a flowchart of a method according to another embodiment of the present disclosure;

FIG. 7d shows a flowchart of PDU session update towards V-SMF or I-SMF according to another embodiment of the present disclosure;

FIG. 7e shows a flowchart of method according to another embodiment of the present disclosure;

FIG. 7f shows a flowchart of method according to another embodiment of the present disclosure;

FIG. 8a is a block diagram showing an apparatus suitable for practicing some embodiments of the disclosure;

FIG. 8b is a block diagram showing a first NF service consumer according to an embodiment of the disclosure;

FIG. 8c is a block diagram showing a second NF service consumer according to an embodiment of the disclosure;

FIG. 8d is a block diagram showing a third NF service consumer according to an embodiment of the disclosure;

FIG. 8e is a block diagram showing a fourth NF service consumer according to an embodiment of the disclosure;

FIG. 8f is a block diagram showing a NF service producer according to an embodiment of the disclosure;

FIG. 9 shows an example of a communication system according to an embodiment of the disclosure;

FIG. 10 is a block diagram of a host according to an embodiment of the disclosure; and

FIG. 11 shows a communication diagram of a host communicating via a network node with a UE over a partially wireless connection according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G, 6G communication protocols, and/or any other protocols either currently known or to be developed in the future.

The term “network device” or “network node” refers to any suitable network function (NF) which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as LTE (Long Term Evolution)) may include MME (Mobile Management Entity), HSS (home subscriber server), Policy and Charging Rules Function (PCRF), Packet Data Network Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

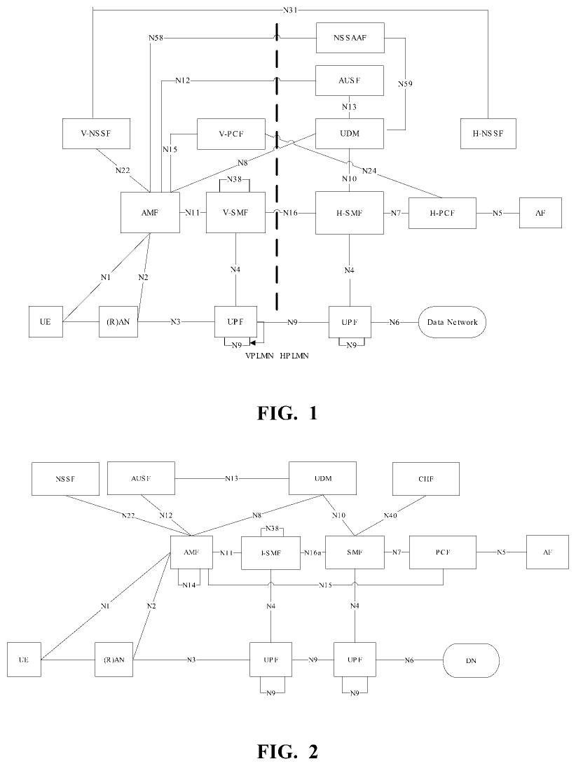

Although the subject matter described herein may be implemented in any appropriate type of system using any suitable components, the embodiments disclosed herein are described in relation to a communication system complied with the exemplary system architecture illustrated in FIGS. 1-2. For simplicity, the system architectures of FIGS. 1-2 only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

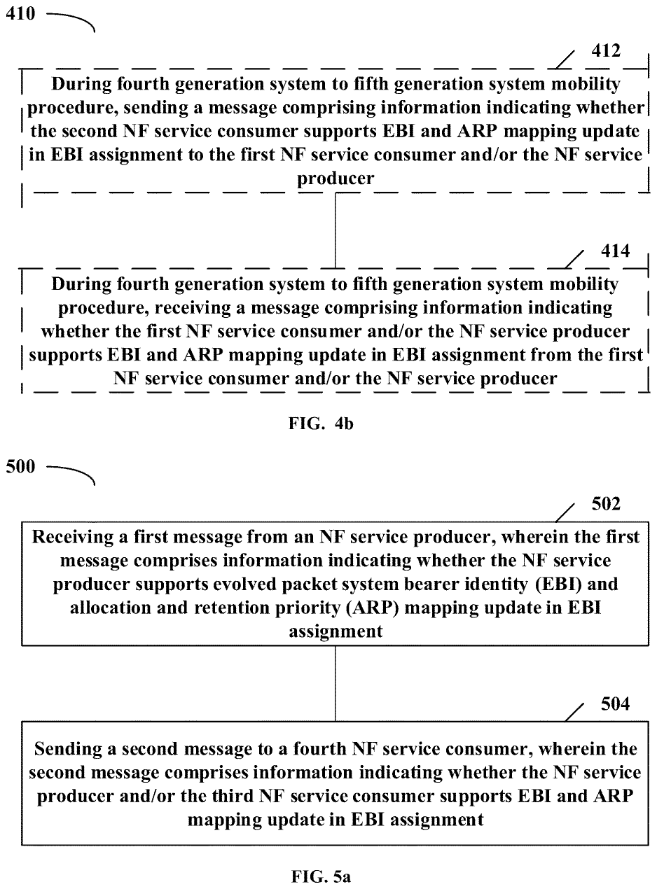

FIG. 1 schematically shows 5G system roaming architecture in the case of home routed scenario using the reference point representation according to an embodiment of the present disclosure. The architecture of FIG. 1 is same as FIG. 4.2.4-6 as described in 3GPP TS 23.501 V18.0.0, the disclosure of which is incorporated by reference herein in its entirety. The system architecture of FIG. 1 may comprise some exemplary elements such as AUSF, AMF, data network, visited NSSF (V-NSSF), home NSSF (H-NSSF), visited PCF (V-PCF), visited SMF (V-SMF), home SMF (H-SMF), UDM, UPF, AF, UE, (R)AN, NSSAAF (Network Slice-Specific Authentication and Authorization Function), etc.

In accordance with an exemplary embodiment, the UE can establish a signaling connection with the AMF over the reference point N1, as illustrated in FIG. 1. This signaling connection may enable NAS (Non-access stratum) signaling exchange between the UE and the core network, comprising a signaling connection between the UE and the (R) AN and the N2 connection for this UE between the (R) AN and the AMF. The (R) AN can communicate with the UPF over the reference point N3. The UE can establish a protocol data unit (PDU) session to the data network (e.g. an operator network or Internet) through the UPF over the reference point N6.

The N38 references point can be between V-SMFs in the same VPLMN, or between V-SMFs in different VPLMNs (to enable inter-PLMN mobility).

For the roaming scenarios described above each PLMN implements proxy functionality to secure interconnection and hide topology on the inter-PLMN interfaces.

As further illustrated in FIG. 1, it also shows some reference points such as N1, N2, N3, N4, N6, N9, N11, N38, N16, N7, N5, N22, N15, N8, N24, N10, N58, N12, N31, N59, N13 etc., which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 1 may be responsible for functions such as session management, mobility management, authentication, security, etc. Various NFs shown in FIG. 1 may include the functionality for example as defined in clause 6.2 of 3GPP TS 23.501 V18.0.0.

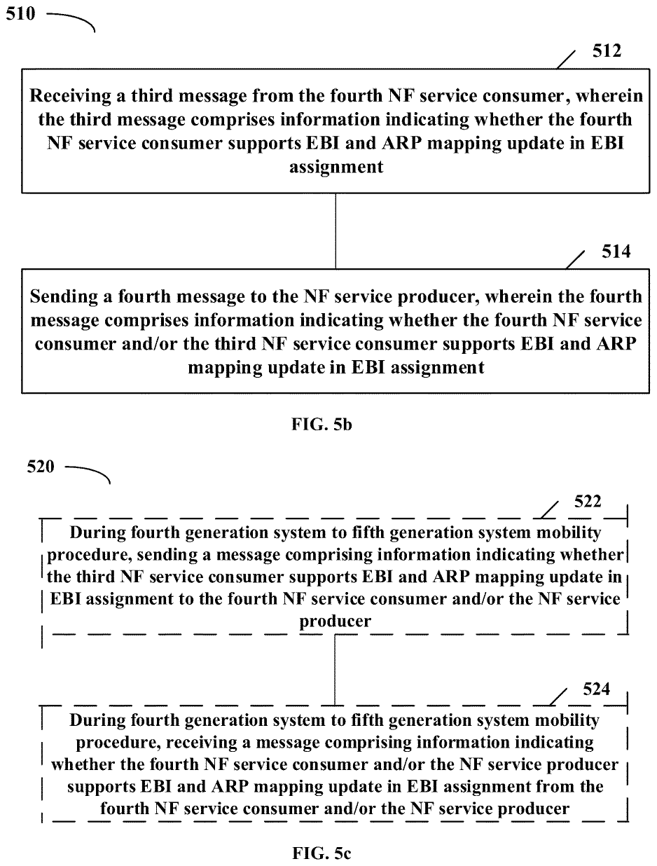

FIG. 2 schematically shows non-roaming architecture with I-SMF insertion to the PDU session in reference point representation, with no Uplink Classifier (UL-CL)/Branching Point (BP) according to an embodiment of the present disclosure. The architecture of FIG. 2 is same as FIG. 5.34.2.2-1 as described in 3GPP TS 23.501 V18.0.0, the disclosure of which is incorporated by reference herein in its entirety. The system architecture of FIG. 2 may comprise some exemplary elements such as AUSF, AMF, DN, NSSF, PCF, I-SMF, SMF, UDM, UPF, AF, UE, (R) AN, CHF (Charging Function), etc.

In accordance with an exemplary embodiment, the UE can establish a signaling connection with the AMF over the reference point N1, as illustrated in FIG. 2. This signaling connection may enable NAS signaling exchange between the UE and the core network, comprising a signaling connection between the UE and the (R) AN and the N2 connection for this UE between the (R) AN and the AMF. The (R) AN can communicate with the UPF over the reference point N3. The UE can establish a PDU session to the data network (e.g. an operator network or Internet) through the UPF over the reference point N6.

N16a is the interface between SMF and I-SMF.

N38 is the interface between I-SMFs.

As further illustrated in FIG. 2, it also shows some reference points such as N1, N2, N3, N4, N6, N9, N11, N14, N16a, N7, N5, N15, N38, N22, N12, N13, N8, N10, N40, N13, etc., which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 2 may be responsible for functions such as session management, mobility management, authentication, security, etc. Various NFs shown in FIG. 2 may include the functionality for example as defined in clause 6.2 of 3GPP TS 23.501 V18.0.0.

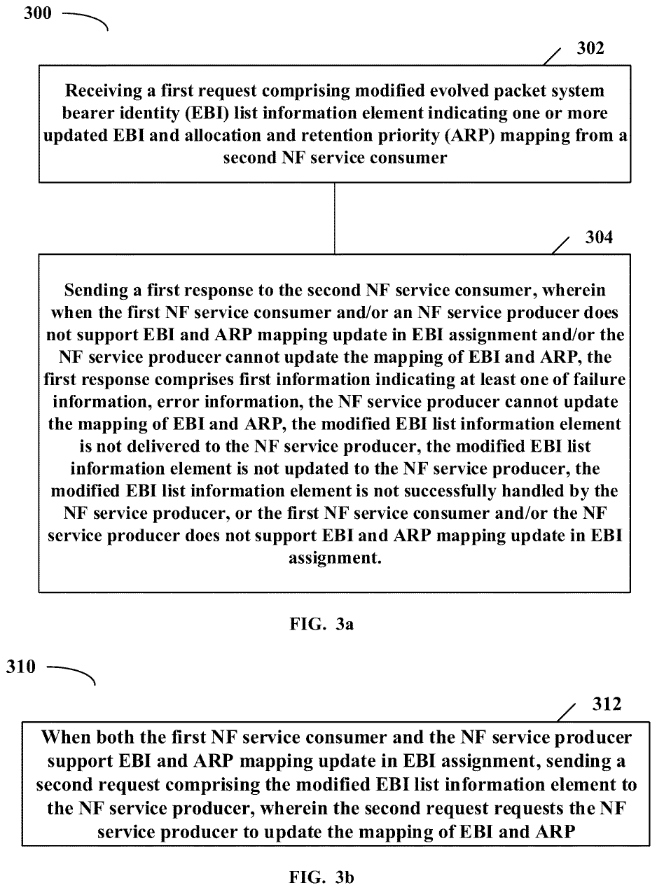

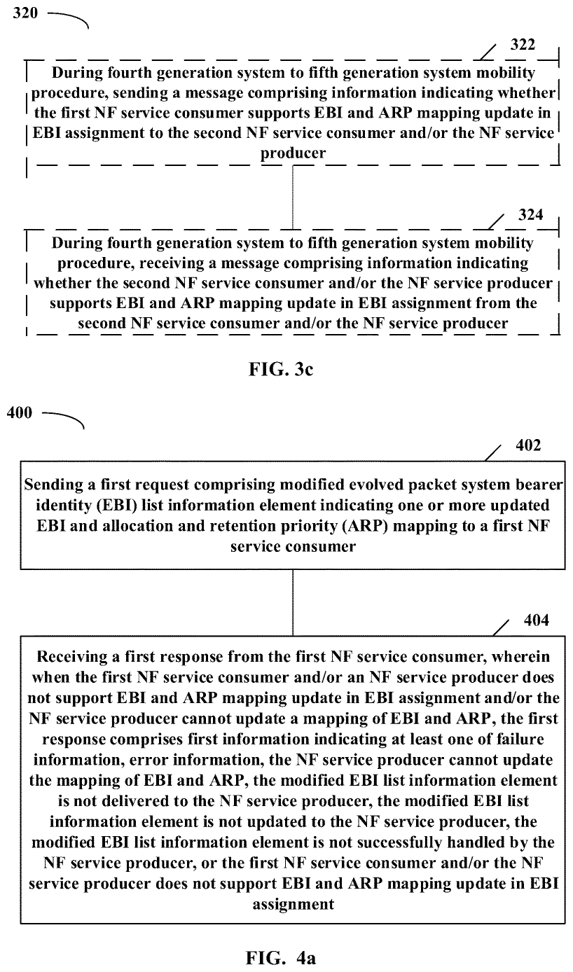

FIG. 3a shows a flowchart of a method according to an embodiment of the present disclosure, which may be performed by an apparatus implemented in or at or as a first network function (NF) service consumer or communicatively coupled to the first NF service consumer. As such, the apparatus may provide means or modules for accomplishing various parts of the method 300 as well as means or modules for accomplishing other processes in conjunction with other components.

At block 302, the first NF service consumer may receive a first request comprising modified evolved packet system bearer identity (EBI) list information element from a second NF service consumer.

In an embodiment, the modified evolved packet system bearer identity (EBI) list information element may indicate one or more updated EBI and allocation and retention priority (ARP) mapping.

In an embodiment, the first request may request a NF service producer to update a mapping of EBI and allocation and retention priority (ARP).

The first NF service consumer may be any suitable network device or node or entity or function. In an embodiment, the first NF service consumer may be an intermediate SMF or a visited SMF as described in 3GPP TS 23.501 V18.0.0.

For example, the I-SMF may be an SMF that is inserted to support a PDU session as the UE is located in an area which cannot be controlled by the original SMF because the UPF(s) belong to a different SMF service area. For example, the V-SMF may be an SMF that is inserted to support a PDU session as the UE is located in a visited network which cannot be controlled by the home SMF because the UPF(s) belong to the visited network.

The second NF service consumer may be any suitable network device or node or entity or function. In an embodiment, the second NF service consumer may be an SMF or a Packet Data Network Gateway control plane (PGW-C) combined with SMF (PGW-C+SMF) or a home SMF or anchor SMF (A-SMF) as described in 3GPP TS 23.501 V18.0.0. For example, the H-SMF may be an SMF that is located in a home network.

For example, the first NF service consumer may be I-SMF and the second NF service consumer may be SMF or anchor SMF or PGW-C+SMF. The first NF service consumer may be V-SMF and the second NF service consumer may be H-SMF.

The NF service producer may be any suitable network device or node or entity or

function. In an embodiment, the NF service producer may be AMF as described in 3GPP TS 23.501 V18.0.0.

The first request may be any suitable message. For example, the first request may be a protocol data unit (PDU) session update request such as Nsmf_PDUSession_Update Request as described in 3GPP TS 23.502 V18.0.0. The Nsmf_PDUSession_Update Request may comprise VsmfUpdateData as described in 3GPP TS 29.502 V18.1.0. The modified EBI list information element may be comprised in VsmfUpdateData.

In an embodiment, the modified EBI list information element may be same as the modifiedEbiList IE as described in 3GPP TS 29.502 V18.1.0.

Table 3 shows modifiedEbiList, which is a copy of Table 6.1.6.2.15-1 Definition of type VsmfUpdateData of 3GPP TS 29.502 V18.1.0.

TABLE 3

| | | | | | |
|---|---|---|---|---|---|
| | | | Cardi- | | Applica- |
| Attribute name | Data type | P | nality | Description | bility |

| | | | | |
|---|---|---|---|---|
| modifiedEbiList | array(EbiArpMapping) | C | 1 . . . N | This IE shall be present if a PDU |
| | | | | session modification procedure |
| | | | | resulted in the change of ARP for |
| | | | | a QoS flow that was already |
| | | | | allocated an EBI. |

Table 4 shows a definition of type EbiArpMapping, which is a copy of Table 6.1.6.2.34-1 of 3GPP TS 29.502 V18.1.0.

TABLE 4

| Attribute name | Data type | P | Cardinality | Description |
|---|---|---|---|---|
| epsBearerId | EpsBearerId | M | 1 | This IE shall contain the EPS bearer identities. |
| arp | Arp | M | 1 | This IE shall contain the ARP corresponding to the |
| | | | | EBI. |

The allocation and retention priority (ARP) may be a QoS parameter which may contain information about the priority level, the pre-emption capability and the pre-emption vulnerability. This allows deciding whether a QoS Flow establishment/modification/handover may be accepted or needs to be rejected in the case of resource limitations (typically used for admission control of GBR (Guaranteed Bit Rate) traffic). It may also be used to decide which existing QoS Flow to pre-empt during resource limitations, i.e. which QoS Flow to release to free up resources.

In an embodiment, the ARP may be same as the ARP as described in various 3GPP specifications such as 3GPP TS 29.502 V18.1.0, 3GPP TS 23.501 V18.0.0, 3GPP TS 29.518 V18.0.0, etc.

In an embodiment, the first request may be received from the second NF service consumer when an ARP for a quality of service (QoS) flow that has already been allocated an EBI is changed. For example, the PCF may trigger ARP change for a current existing QoS flow and send Npcf_SMPolicyControl_UpdateNotify Request (PCC (Policy and Charging Control) rules with different 5QI (5G QOS Identifier)) to the second NF service consumer such as SMF. Then the second NF service consumer may send to the first NF service consumer the first request comprising the modified EBI list information element.

In an embodiment, the second NF service consumer does not know whether the first NF service consumer and/or the NF service producer supports EBI and ARP mapping update in EBI assignment.

At block 304, the first NF service consumer may send a first response to the second NF service consumer.

In an embodiment, when the first NF service consumer and/or an NF service producer does not support EBI and ARP mapping update in EBI assignment (i.e., EAEA) and/or the NF service producer cannot update a mapping of EBI and ARP, the first response may comprise first information indicating at least one of failure information, error information, the NF service producer cannot update the mapping of EBI and ARP, the modified EBI list information element is not delivered to the NF service producer, the modified EBI list information element is not updated to the NF service producer, the modified EBI list information element is not successfully handled by the NF service producer, or the first NF service consumer and/or the NF service producer does not support EBI and ARP mapping update in EBI assignment.

The failure information and/or error information may enable the second NF service consumer to know that the NF service producer cannot update the mapping of EBI and ARP, the modified EBI list information element is not delivered to the NF service producer, the modified EBI list information element is not updated to the NF service producer, the modified EBI list information element is not successfully handled by the NF service producer, or the first NF service consumer and/or the NF service producer does not support EBI and ARP mapping update in EBI assignment.

The EBI assignment is described in clause 5.2.2.6 of 3GPP TS 29.518 V18.0.0. The EBI assignment service operation may be invoked by an NF Service Consumer, e.g. an SMF, towards the NF Service Producer supporting the EAEA feature, i.e. the AMF, to request the AMF to update the mapping of EBI and ARP, if the ARP for a QoS flow that has already been allocated an EBI is changed during the network requested PDU Session Modification.

The first NF service consumer may know whether the NF service producer supports EBI and ARP mapping update in EBI assignment (i.e., EAEA) in various ways. For example, the feature negotiation mechanism specified in clause 6.6 of 3GPP TS 29.500 V18.0.0, the disclosure of which is incorporated by reference herein in its entirety, may be used to negotiate the optional features applicable between the first NF service consumer and the NF service producer for a service such as Namf_Communication service. The NF Service Consumer may indicate the optional features it supports for the service such as Namf_Communication service by including the supported features attribute in payload of the Hyper Text Transfer Protocol (HTTP) Request Message. The NF service producer may determine the supported features for the service operation and may indicate the supported features by including the supported features attribute in payload of the HTTP response for the service operation.

The first response may be any suitable message. For example, the first response may be a PDU session update response such as Nsmf_PDUSession_Update response as described in 3GPP TS 23.502 V18.0.0. The Nsmf_PDUSession_Update response may comprise VsmfUpdatedData as described in 3GPP TS 29.502 V18.1.0.

In an embodiment, the first information may be comprised in visited SMF updated data such as VsmfUpdatedData.

The first information may be any suitable information such as bit, flag, indication, indicator, etc. In an embodiment, the first information may be a modified EBI List No Delivery indication.

In an embodiment, a data type of the first information may be Boolean. In an embodiment, the first information may be set as true.

In an embodiment, if the modified EBI list information element is present in the request in the first request, the first NF service consumer such as V-SMF or I-SMF may request the NF service producer such as AMF to update the mapping of EBI and ARP if EAEA feature is supported by both the NF service producer such as AMF and the first NF service consumer such as V-SMF or I-SMF, otherwise the first NF service consumer such as V-SMF or I-SMF may indicate in the first response that the modified EBI list information element is not delivered to the NF service producer such as AMF.

FIG. 3b shows a flowchart of a method according to another embodiment of the present disclosure, which may be performed by an apparatus implemented in or at or as a first NF service consumer or communicatively coupled to the first NF service consumer. As such, the apparatus may provide means or modules for accomplishing various parts of the method 310 as well as means or modules for accomplishing other processes in conjunction with other components. For some parts which have been described in the above embodiments, the description thereof is omitted here for brevity.

At block 312, when both the first NF service consumer and the NF service producer support EBI and ARP mapping update in EBI assignment, the first NF service consumer may send a second request comprising the modified EBI list information element to the NF service producer. The second request requests the NF service producer to update the mapping of EBI and ARP.

The second request may be any suitable message. For example, the second request may be an EBI assignment request such as Namf_Communication_EBIAssignment request as described in 3GPP TS 23.502 V18.0.0 or the EBI assignment request as described in 3GPP TS 29.518 V18.0.0.

If the second request comprises the modified EBI list information element, the NF service producer such as AMF may store the association of the assigned EBI and ARP pair to the corresponding PDU Session ID. The NF service producer such as AMF shall respond with the status code 200 OK and may include the EBI(s) with ARP updated in the “modifiedEbiList” IE of the POST response body.

In an embodiment, when both the first NF service consumer and the NF service producer support EBI and ARP mapping update in EBI assignment and/or the NF service producer has updated the mapping of EBI and ARP, the first response may comprise second information indicating at least one of successful information, the NF service producer has updated the mapping of EBI and ARP, the modified EBI list information element is delivered to the NF service producer, the modified EBI list information element is updated to the NF service producer, the modified EBI list information element is successfully handled by the NF service producer or the first NF service consumer and the NF service producer support EBI and ARP mapping update in EBI assignment.

The successful information may indicate that the NF service producer has updated the mapping of EBI and ARP, the modified EBI list information element is delivered to the NF service producer, the modified EBI list information element is updated to the NF service producer, the modified EBI list information element is successfully handled by the NF service producer, or the first NF service consumer and the NF service producer support EBI and ARP mapping update in EBI assignment.

In an embodiment, the first response may comprise the EBI(s) with ARP updated in the “modifiedEbiList” IE of the POST response body.

The second information may be any suitable information such as bit, flag, indication, indicator, etc. In an embodiment, the second information may be a modified EBI List No Delivery indication.

In an embodiment, the second information is comprised in visited SMF updated data.

In an embodiment, a data type of the second information may be Boolean. In an embodiment, the second information may be set as false.

In an embodiment, the first information and the second information may be indicated by a modified EBI List No Delivery Indication IE. This IE may be present with the value “true” when the modified EBI list IE was received in the first request but cannot be updated to the NF service producer such as AMF, e.g. during (H-)SMF triggered PDU session modification procedure and the NF service producer such as AMF doesn't support the EAEA feature.

In an embodiment, when the modified EBI List No Delivery Indication IE is present, the IE may be set as following:
true: the received modified EBI list is not updated to the NF service producer such as AMF.
false: the received modified EBI list is updated to the NF service producer such as AMF.

FIG. 3c shows a flowchart of a method according to another embodiment of the present disclosure, which may be performed by an apparatus implemented in or at or as a first NF service consumer or communicatively coupled to the first NF service consumer. As such, the apparatus may provide means or modules for accomplishing various parts of the method 320 as well as means or modules for accomplishing other processes in conjunction with other components. For some parts which have been described in the above embodiments, the description thereof is omitted here for brevity.

At block 322, optionally, during fourth generation system to fifth generation system mobility procedure, the first NF service consumer may send a message comprising information indicating whether the first NF service consumer supports EBI and ARP mapping update in EBI assignment to the second NF service consumer and/or the NF service producer.

At block 324, optionally, during fourth generation system to fifth generation system mobility procedure, the first NF service consumer may receive a message comprising information indicating whether the second NF service consumer and/or the NF service producer supports EBI and ARP mapping update in EBI assignment from the second NF service consumer and/or the NF service producer.

The information may be any suitable information such as bit, flag, indication, indicator, etc. In an embodiment, the first information may be a modified EBI List No Delivery indication.

In an embodiment, a data type of the information is Boolean. In an embodiment, the information may be set as false when an NF does not support EBI and ARP mapping update in EBI assignment. The information may be set as true when an NF supports EBI and ARP mapping update in EBI assignment.

The fourth generation system may be 4G system (such as EPS) as defined by 3GPP. The fifth generation system may be 5G system (such as 5GS) as defined by 3GPP.

The fourth generation system to fifth generation system mobility procedure may be any suitable fourth generation system to fifth generation system mobility procedure as defined by various 3GPP specifications such as 3GPP TS 23.502 V18.0.0, 3GPP TS 29.502 V18.1.0, etc. For example, the fourth generation system to fifth generation system mobility procedure may be EPS to 5GS Mobility Registration Procedure (Idle and Connected State) using N26 interface as described in clause 4.11.1.3.3 of 3GPP TS 23.502 V18.0.0.

The message may be any suitable message which can be sent from the first NF service consumer to the second NF service consumer and/or the NF service producer and from the second NF service consumer and/or the NF service producer to the first NF service consumer. For example, when the first NF service consumer is an I-SMF or V-SMF, the second NF service consumer is SMF, H-SMF or PGW-C combined SMF and the NF service producer is an AMF, the message may be any suitable message which can be exchanged between these network functions for example as defined by various 3GPP specifications such as 3GPP TS 23.502 V18.0.0, 3GPP TS 29.502 V18.1.0, 3GPP TS 29.518 V18.0.0, etc.

For example, the feature negotiation mechanism specified in clause 6.6 of 3GPP TS 29.500 V18.0.0 may be used to negotiate the optional features applicable between the AMF and the NF Service Consumer, for the Namf_Communication service, if any.

For example, the NF Service Consumer may indicate the optional features it supports for the Namf_Communication service, if any, by including the supportedFeatures attribute in payload of the HTTP Request Message for following service operations:
N1N2MessgeTransfer, as specified in clause 5.2.2.3.1 of 3GPP TS 29.518 V18.0.0;
N1N2MessageSubscribe, as specified in clause 5.2.2.3.3 of 3GPP TS 29.518 V18.0.0;
NonUeN2InfoSubscribe, as specified in clause 5.2.2.4.2 of 3GPP TS 29.518 V18.0.0;
UeContextTransfer, as specified in clause 5.2.2.2.1 of 3GPP TS 29.518 V18.0.0;
CreateUEContext, as specified in clause 5.2.2.2.3 of 3GPP TS 29.518 V18.0.0.

With this embodiment, when a session moves from 4G to 5G, the NF service consumer such as SMF can negotiate with the NF service producer (such as AMF) and/or another NF service consumer (such as SMF) with EAEA feature.

FIG. 4a shows a flowchart of a method according to another embodiment of the present disclosure, which may be performed by an apparatus implemented in or at or as a second NF service consumer or communicatively coupled to the second NF service consumer. As such, the apparatus may provide means or modules for accomplishing various parts of the method 400 as well as means or modules for accomplishing other processes in conjunction with other components. For some parts which have been described in the above embodiments, the description thereof is omitted here for brevity.

At block 402, the second NF service consumer may send a first request comprising modified evolved packet system bearer identity (EBI) list information element to a first NF service consumer.

In an embodiment, the modified evolved packet system bearer identity (EBI) list information element may indicate one or more updated EBI and allocation and retention priority (ARP) mapping.

In an embodiment, the first request may request a NF service producer to update a mapping of EBI and allocation and retention priority (ARP).

In an embodiment, the first NF service consumer may comprise at least one of an intermediate SMF or a visited SMF.

In an embodiment, the second NF service consumer may comprise at least one of an SMF, a PGW-C combined with SMF, or a home SMF.

In an embodiment, the NF service producer may comprise an access and mobility management function (AMF).

In an embodiment, the first request may be a PDU session update request.

In an embodiment, the first request is sent to the first NF service consumer when an ARP for a quality of service (QoS) flow that has already been allocated an EBI is changed.

In an embodiment, the second NF service consumer does not know whether the first NF service consumer and/or the NF service producer supports EBI and ARP mapping update in EBI assignment.

At block 404, the second NF service consumer may receive a first response from the first NF service consumer.

In an embodiment, when the first NF service consumer and/or an NF service producer does not support EBI and ARP mapping update in EBI assignment and/or the NF service producer cannot update a mapping of EBI and ARP, the first response may comprise first information indicating at least one of failure information, error information, the NF service producer cannot update the mapping of EBI and ARP, the modified EBI list information element is not delivered to the NF service producer, the modified EBI list information element is not updated to the NF service producer, the modified EBI list information element is not successfully handled by the NF service producer, or the first NF service consumer and/or the NF service producer does not support EBI and ARP mapping update in EBI assignment.

In an embodiment, when the second NF service consumer know that the NF service producer cannot update the mapping of EBI and ARP, the modified EBI list information element is not delivered to the NF service producer, etc., it may perform any suitable operations for example based on a policy, such as remaining this status, notifying a notification of a failure of ARP change to PCF, triggering a release of the EBI and assigning the EBI, etc.

In an embodiment, the first response may be a PDU session update response.

In an embodiment, the first information may be comprised in visited SMF updated data.

In an embodiment, a data type of the first information may be Boolean. The first information may be set as true.

In an embodiment, when both the first NF service consumer and the NF service producer support EBI and ARP mapping update in EBI assignment and/or the NF service producer has updated the mapping of EBI and ARP, the first response may comprise second information indicating at least one of successful information, the NF service producer has updated the mapping of EBI and ARP, the modified EBI list information element is delivered to the NF service producer, the modified EBI list information element is updated to the NF service producer, the modified EBI list information element is successfully handled by the NF service producer, or the first NF service consumer and the NF service producer support EBI and ARP mapping update in EBI assignment.

In an embodiment, the second information may be comprised in visited SMF updated data.

In an embodiment, a data type of the second information may be Boolean. The second information may be set as false.

With these embodiments, the second NF service consumer may know whether the NF service producer and/or the third NF service consumer supports EBI and ARP mapping update in EBI assignment. Then the fourth NF service consumer may perform any suitable operations. For example, the fourth NF service consumer may know whether to send a request comprising modified EBI list information element to the third NF service consumer. For example, when both the NF service producer and the third NF service consumer support EBI and ARP mapping update in EBI assignment and an ARP for a QoS flow that has already been allocated an EBI is changed, the fourth NF service consumer may send a request comprising modified EBI list information element to the third NF service consumer. Otherwise the fourth NF service consumer may not send the request comprising modified EBI list information element to the third NF service consumer. The fourth NF service consumer may perform any other suitable operation to request the NF service producer to update the mapping of EBI and ARP.

FIG. 4b shows a flowchart of a method according to another embodiment of the present disclosure, which may be performed by an apparatus implemented in or at or as a second NF service consumer or communicatively coupled to the second NF service consumer. As such, the apparatus may provide means or modules for accomplishing various parts of the method 410 as well as means or modules for accomplishing other processes in conjunction with other components. For some parts which have been described in the above embodiments, the description thereof is omitted here for brevity.

At block 412, optionally, during fourth generation system to fifth generation system mobility procedure, the second NF service consumer may send a message comprising information indicating whether the second NF service consumer supports EBI and ARP mapping update in EBI assignment to the first NF service consumer and/or the NF service producer.

At block 414, optionally, during fourth generation system to fifth generation system mobility procedure, the second NF service consumer may receive a message comprising information indicating whether the first NF service consumer and/or the NF service producer supports EBI and ARP mapping update in EBI assignment from the first NF service consumer and/or the NF service producer.

With this embodiment, when a session moves from 4G to 5G, the NF service consumer such as SMF can negotiate with the NF service producer (such as AMF) and/or another NF service consumer (such as SMF) with EAEA feature.

FIG. 5a shows a flowchart of a method according to another embodiment of the present disclosure, which may be performed by an apparatus implemented in or at or as a third NF service consumer or communicatively coupled to the third NF service consumer. As such, the apparatus may provide means or modules for accomplishing various parts of the method 500 as well as means or modules for accomplishing other processes in conjunction with other components. For some parts which have been described in the above embodiments, the description thereof is omitted here for brevity.

At block 502, the third NF service consumer may receive a first message from an NF service producer. The first message may comprise information indicating whether the NF service producer supports EBI and ARP mapping update in EBI assignment.

The third NF service consumer may be any suitable network device or node or entity or function. In an embodiment, the third NF service consumer may be an intermediate SMF or a visited SMF as described in 3GPP TS 23.501 V18.0.0.

The NF service producer may be any suitable network device or node or entity or function. In an embodiment, the NF service producer may be AMF as described in 3GPP TS 23.501 V18.0.0.

The first message may be any suitable message. For example, the first message may be a PDU session management create session context request such as Nsmf_PDUSession_CreateSMContext Request as described in 3GPP TS 23.502 V18.0.0.

In an embodiment, the ARP may be same as the ARP as described in various 3GPP specifications such as 3GPP TS 29.502 V18.1.0, 3GPP TS 23.501 V18.0.0, 3GPP TS 29.518 V18.0.0, etc.

The EBI assignment is described in clause 5.2.2.6 of 3GPP TS 29.518 V18.0.0. The EBI assignment service operation may be invoked by an NF Service Consumer, e.g. an SMF, towards the NF Service Producer supporting the EAEA feature, i.e. the AMF, to request the AMF to update the mapping of EBI and ARP, if the ARP for a QoS flow that has already been allocated an EBI is changed during the network requested PDU Session Modification.

The information indicating whether the NF service producer supports EBI and ARP mapping update in EBI assignment may be any suitable information such as bit, flag, indication, indicator, etc.

In an embodiment, a data type of the information may be Boolean. For example, the information may be set as true when the NF service producer supports EBI and ARP mapping update in EBI assignment. The information may be set as false when the NF service producer does not support EBI and ARP mapping update in EBI assignment.

With these embodiments, the third NF service consumer may know whether the NF service producer supports EBI and ARP mapping update in EBI assignment. Then the third NF service consumer may perform any suitable operations. For example, the third NF service consumer may know whether to send a request comprising modified EBI list information element to the NF service producer. For example, when the NF service producer supports EBI and ARP mapping update in EBI assignment and an ARP for a QoS flow that has already been allocated an EBI is changed, the third NF service consumer may send a request comprising modified EBI list information element to the NF service producer. Otherwise the third NF service consumer may not send the request comprising modified EBI list information element to the NF service producer. When the modified EBI list information element is received from the fourth NF service consumer, the third NF service consumer may send to the fourth NF service consumer information indicating at least one of failure information, error information, the NF service producer cannot update the mapping of EBI and ARP, the modified EBI list information element is not delivered to the NF service producer, the modified EBI list information element is not updated to the NF service producer, the modified EBI list information element is not successfully handled by the NF service producer, or the first NF service consumer and/or the NF service producer does not support EBI and ARP mapping update in EBI assignment.

At block 504, the third NF service consumer may send a second message to a fourth NF service consumer. The second message may comprise information indicating whether the NF service producer and/or the third NF service consumer supports EBI and ARP mapping update in EBI assignment.

The fourth NF service consumer may be any suitable network device or node or

entity or function. In an embodiment, the fourth NF service consumer may be an SMF or a PGW-C combined with SMF or a home SMF or anchor SMF as described in 3GPP TS 23.501 V18.0.0. For example, the H-SMF may be an SMF that is located in a home network.

For example, the third NF service consumer may be I-SMF and the fourth NF service consumer may be SMF or anchor SMF. The third NF service consumer may be V-SMF and the fourth NF service consumer may be H-SMF.

The second message may be any suitable message. For example, the second message may be a PDU session create request such as Nsmf_PDUSession_Create Request as described in 3GPP TS 23.502 V18.0.0.

The information indicating whether the third NF service consumer supports EBI and ARP mapping update in EBI assignment may be any suitable information such as bit, flag, indication, etc.

In an embodiment, a data type of the information may be Boolean. For example, the information for the third NF service consumer may be set as true when the third NF service consumer supports EBI and ARP mapping update in EBI assignment. The information for the third NF service consumer may be set as false when the third NF service consumer does not support EBI and ARP mapping update in EBI assignment. For example, the information for the NF service producer may be set as true when the NF service producer supports EBI and ARP mapping update in EBI assignment. The information for the NF service producer may be set as false when the NF service producer does not support EBI and ARP mapping update in EBI assignment. For example, the information may be set as true when both the NF service producer and the third NF service consumer support EBI and ARP mapping update in EBI assignment. The information may be set as false when the NF service producer and/or the third NF service consumer does not support EBI and ARP mapping update in EBI assignment.

In an embodiment, the first message may be received from the NF service producer and the second message may be sent to the fourth NF service consumer during a PDU session establishment procedure.

In an embodiment, the PDU session establishment procedure may involve I-SMF or V-SMF.

In an embodiment, the PDU session establishment procedure may comprise at least one of a UE initiated PDU Session Establishment procedure, a UE initiated PDU Session handover between 3GPP and non-3GPP, a UE initiated PDU Session handover from EPS to 5GS, or a Network triggered PDU Session Establishment procedure as described in 3GPP TS 23.502 V18.0.0.

With these embodiments, the fourth NF service consumer may know whether the NF service producer and/or the third NF service consumer supports EBI and ARP mapping update in EBI assignment. Then the fourth NF service consumer may perform any suitable operations. For example, the fourth NF service consumer may know whether to send a request comprising modified EBI list information element to the third NF service consumer. For example, when both the NF service producer and the third NF service consumer support EBI and ARP mapping update in EBI assignment and an ARP for a QoS flow that has already been allocated an EBI is changed, the fourth NF service consumer may send a request comprising modified EBI list information element to the third NF service consumer. Otherwise the fourth NF service consumer may not send the request comprising modified EBI list information element to the third NF service consumer. The fourth NF service consumer may perform any other suitable operation for example based on a policy, such as remaining this status, notifying a notification of a failure of ARP change to PCF, triggering a release of the EBI and assigning the EBI, etc.

FIG. 5b shows a flowchart of a method according to another embodiment of the present disclosure, which may be performed by an apparatus implemented in or at or as a third NF service consumer or communicatively coupled to the third NF service consumer. As such, the apparatus may provide means or modules for accomplishing various parts of the method 510 as well as means or modules for accomplishing other processes in conjunction with other components. For some parts which have been described in the above embodiments, the description thereof is omitted here for brevity.

At block 512, the third NF service consumer may receive a third message from the fourth NF service consumer. The third message may comprise information indicating whether the fourth NF service consumer supports EBI and ARP mapping update in EBI assignment.

The third message may be any suitable message. For example, the third message may be a PDU session create response such as Nsmf_PDUSession_Create Response as described in 3GPP TS 23.502 V18.0.0.

The information indicating whether the fourth NF service consumer supports EBI and ARP mapping update in EBI assignment may be any suitable information such as bit, flag, indication, indicator, etc.

In an embodiment, a data type of the information may be Boolean. For example, the information may be set as true when the fourth NF service consumer supports EBI and ARP mapping update in EBI assignment. The information may be set as false when the fourth NF service consumer does not support EBI and ARP mapping update in EBI assignment.

At block 514, the third NF service consumer may send a fourth message to the NF service producer. The fourth message may comprise information indicating whether the fourth NF service consumer and/or the third NF service consumer supports EBI and ARP mapping update in EBI assignment.

The information indicating whether the fourth NF service consumer and/or the third NF service consumer supports EBI and ARP mapping update in EBI assignment may be any suitable information such as bit, flag, indication, indicator, etc.

In an embodiment, a data type of the information may be Boolean. For example, the information for the fourth NF service consumer may be set as true when the fourth NF service consumer supports EBI and ARP mapping update in EBI assignment. The information for the fourth NF service consumer may be set as false when the fourth NF service consumer does not support EBI and ARP mapping update in EBI assignment. For example, the information for the third NF service consumer may be set as true when the third NF service consumer supports EBI and ARP mapping update in EBI assignment. The information for the third NF service consumer may be set as false when the third NF service consumer does not support EBI and ARP mapping update in EBI assignment.

The fourth message may be any suitable message. In an embodiment, the fourth message may be an Namf_Communication_N1N2MessageTransfer message as described in 3GPP TS 23.502 V18.0.0.

In an embodiment, the third message may be received from the fourth NF service consumer and the fourth message may be sent to the NF service producer during a PDU session establishment procedure.

FIG. 5c shows a flowchart of a method according to another embodiment of the present disclosure, which may be performed by an apparatus implemented in or at or as a third NF service consumer or communicatively coupled to the third NF service consumer. As such, the apparatus may provide means or modules for accomplishing various parts of the method 520 as well as means or modules for accomplishing other processes in conjunction with other components. For some parts which have been described in the above embodiments, the description thereof is omitted here for brevity.

At block 522, optionally, during fourth generation system to fifth generation system mobility procedure, the third NF service consumer may send a message comprising information indicating whether the third NF service consumer supports EBI and ARP mapping update in EBI assignment to the fourth NF service consumer and/or the NF service producer.

At block 524, optionally, during fourth generation system to fifth generation system mobility procedure, the third NF service consumer may receive a message comprising information indicating whether the fourth NF service consumer and/or the NF service producer supports EBI and ARP mapping update in EBI assignment from the fourth NF service consumer and/or the NF service producer.

Blocks 522 and 524 are similar to blocks 322 and 324 of FIG. 3c.

With this embodiment, when a session moves from 4G to 5G, the NF service consumer such as SMF can negotiate with the NF service producer (such as AMF) and/or another NF service consumer (such as SMF) with EAEA feature.

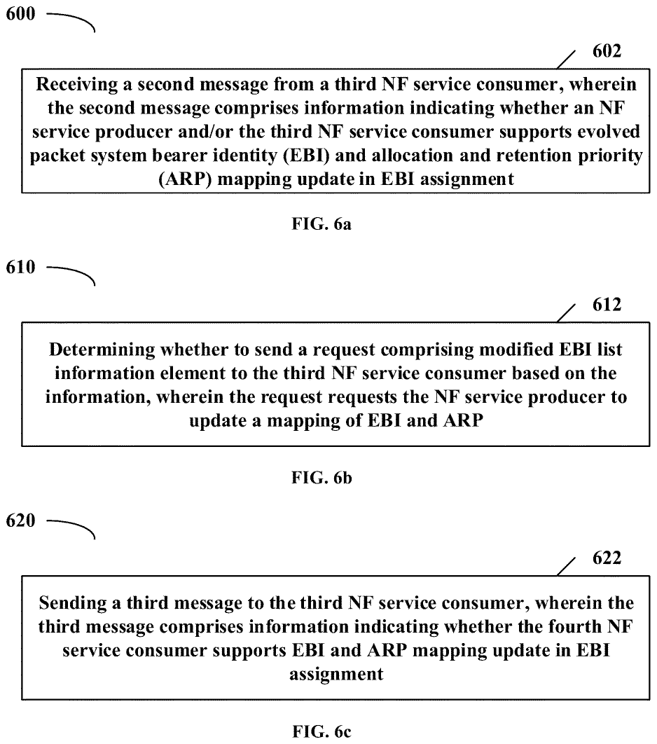

FIG. 6a shows a flowchart of a method according to another embodiment of the present disclosure, which may be performed by an apparatus implemented in or at or as a fourth NF service consumer or communicatively coupled to the fourth NF service consumer. As such, the apparatus may provide means or modules for accomplishing various parts of the method 600 as well as means or modules for accomplishing other processes in conjunction with other components. For some parts which have been described in the above embodiments, the description thereof is omitted here for brevity.

At block 602, the fourth NF service consumer may receive a second message from a third NF service consumer. The second message comprises information indicating whether an NF service producer and/or the third NF service consumer supports evolved packet system bearer identity (EBI) and allocation and retention priority (ARP) mapping update in EBI assignment.

In an embodiment, the second message may be a PDU session create request.

In an embodiment, the second message may be received from the third NF service consumer during a PDU session establishment procedure.

In an embodiment, the third NF service consumer may comprise at least one of an intermediate SMF or a visited SMF.

In an embodiment, the fourth NF service consumer may comprise at least one of an SMF, a PGW-C combined with SMF, or a home SMF.

In an embodiment, the NF service producer comprises an AMF.

FIG. 6b shows a flowchart of a method according to another embodiment of the present disclosure, which may be performed by an apparatus implemented in or at or as a fourth NF service consumer or communicatively coupled to the fourth NF service consumer. As such, the apparatus may provide means or modules for accomplishing various parts of the method 610 as well as means or modules for accomplishing other processes in conjunction with other components. For some parts which have been described in the above embodiments, the description thereof is omitted here for brevity.

At block 612, the fourth NF service consumer may determine whether to send a request comprising modified EBI list information element to the third NF service consumer based on the information. The request requests the NF service producer to update a mapping of EBI and ARP.

For example, when the information indicates the NF service producer and the third NF service consumer supports EBI and ARP mapping update in EBI assignment and the ARP for a QoS flow that has already been allocated an EBI is changed, the fourth NF service consumer may send a request comprising modified EBI list information element to the third NF service consumer. Otherwise the fourth NF service consumer may not send the request and may perform any other suitable operation for example based a policy.

FIG. 6c shows a flowchart of a method according to another embodiment of the present disclosure, which may be performed by an apparatus implemented in or at or as a fourth NF service consumer or communicatively coupled to the fourth NF service consumer. As such, the apparatus may provide means or modules for accomplishing various parts of the method 620 as well as means or modules for accomplishing other processes in conjunction with other components. For some parts which have been described in the above embodiments, the description thereof is omitted here for brevity.

At block 622, the fourth NF service consumer may sending a third message to the third NF service consumer. The third message comprises information indicating whether the fourth NF service consumer supports EBI and ARP mapping update in EBI assignment.

In an embodiment, the third message may be a PDU session create response.

In an embodiment, the third message is sent to the third NF service consumer during a PDU session establishment procedure.

FIG. 6d shows a flowchart of a method according to another embodiment of the present disclosure, which may be performed by an apparatus implemented in or at or as a fourth NF service consumer or communicatively coupled to the fourth NF service consumer. As such, the apparatus may provide means or modules for accomplishing various parts of the method 630 as well as means or modules for accomplishing other processes in conjunction with other components. For some parts which have been described in the above embodiments, the description thereof is omitted here for brevity.

At block 632, optionally, during fourth generation system to fifth generation system mobility procedure, the fourth NF service consumer may send a message comprising information indicating whether the fourth NF service consumer supports EBI and ARP mapping update in EBI assignment to the third NF service consumer and/or the NF service producer.

At block 634, optionally, during fourth generation system to fifth generation system mobility procedure, the fourth NF service consumer may receive a message comprising information indicating whether the third NF service consumer and/or the NF service producer supports EBI and ARP mapping update in EBI assignment from the third NF service consumer and/or the NF service producer.

Blocks 632 and 634 are similar to blocks 412 and 414 of FIG. 4b.

With this embodiment, when a session moves from 4G to 5G, the NF service consumer such as SMF can negotiate with the NF service producer (such as AMF) and/or another NF service consumer (such as SMF) with EAEA feature.

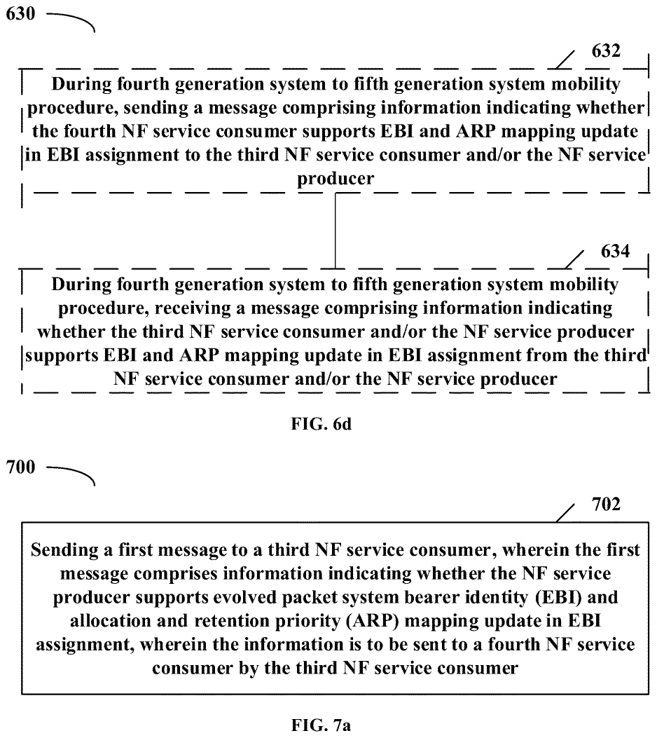

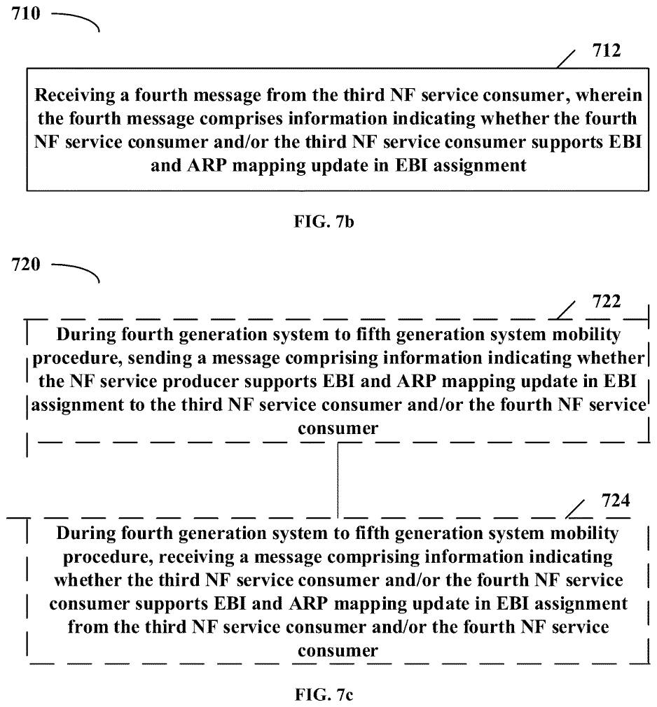

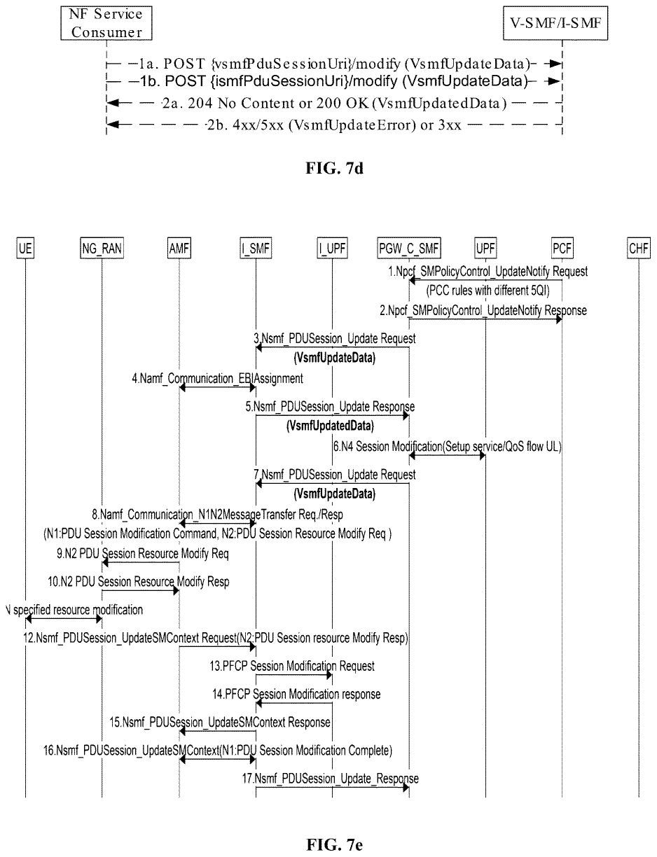

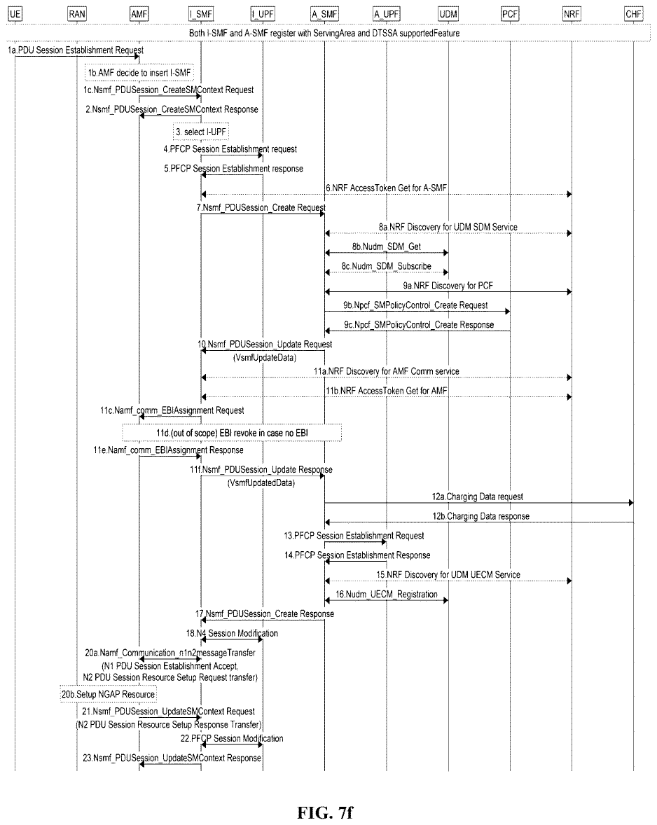

FIG. 7a shows a flowchart of a method according to another embodiment of the present disclosure, which may be performed by an apparatus implemented in or at or as an NF service producer or communicatively coupled to the NF service producer. As such, the apparatus may provide means or modules for accomplishing various parts of the method 700 as well as means or modules for accomplishing other processes in conjunction with other components. For some parts which have been described in the above embodiments, the description thereof is omitted here for brevity.

At block 702, the NF service producer may send a first message to a third NF service consumer.

In an embodiment, the first message may comprise information indicating whether the NF service producer supports evolved packet system bearer identity (EBI) and allocation and retention priority (ARP) mapping update in EBI assignment.

In an embodiment, the information is to be sent to a fourth NF service consumer by the third NF service consumer.

In an embodiment, the first message may be a PDU session create session management context request.

In an embodiment, the first message may be sent to the third NF service consumer during a PDU session establishment procedure.

In an embodiment, the third NF service consumer may comprise at least one of an intermediate SMF or a visited SMF.

In an embodiment, the fourth NF service consumer comprises at least one of an SMF, a Packet Data Network Gateway control plane (PGW-C) combined with SMF, or a home SMF.

In an embodiment, the NF service producer comprises an access and mobility management function (AMF).

FIG. 7b shows a flowchart of a method according to another embodiment of the present disclosure, which may be performed by an apparatus implemented in or at or as an NF service producer or communicatively coupled to the NF service producer. As such, the apparatus may provide means or modules for accomplishing various parts of the method 710 as well as means or modules for accomplishing other processes in conjunction with other components. For some parts which have been described in the above embodiments, the description thereof is omitted here for brevity.

At block 712, the NF service producer may receive a fourth message from the third NF service consumer. The fourth message may comprise information indicating whether the fourth NF service consumer and/or the third NF service consumer supports EBI and ARP mapping update in EBI assignment.

In an embodiment, the fourth message is an Namf_Communication_N1N2MessageTransfer message.

In an embodiment, the fourth message is received from the third NF service consumer during a PDU session establishment procedure.

FIG. 7c shows a flowchart of a method according to another embodiment of the present disclosure, which may be performed by an apparatus implemented in or at or as an NF service producer or communicatively coupled to the NF service producer. As such, the apparatus may provide means or modules for accomplishing various parts of the method 720 as well as means or modules for accomplishing other processes in conjunction with other components. For some parts which have been described in the above embodiments, the description thereof is omitted here for brevity.

At block 722, optionally, during fourth generation system to fifth generation system mobility procedure, the NF service producer may send a message comprising information indicating whether the NF service producer supports EBI and ARP mapping update in EBI assignment to the third NF service consumer and/or the fourth NF service consumer.

At block 724, optionally, during fourth generation system to fifth generation system mobility procedure, the NF service producer may receive a message comprising information indicating whether the third NF service consumer and/or the fourth NF service consumer supports EBI and ARP mapping update in EBI assignment from the third NF service consumer and/or the fourth NF service consumer.

With this embodiment, when a session moves from 4G to 5G, the NF service consumer such as SMF can negotiate with the NF service producer (such as AMF) and/or another NF service consumer (such as SMF) with EAEA feature.

FIG. 7d shows a flowchart of PDU session update towards V-SMF or I-SMF according to another embodiment of the present disclosure, which is same as FIG. 5.2.2.8.3.1-1 of 3GPP TS 29.502 V18.1.0.

The following content is a copy of clause 5.2.2.8.3.1 of 3GPP TS 29.502 V18.1.0.

The NF Service Consumer (i.e. the H-SMF for a HR PDU session, or the SMF for a PDU session with an I-SMF) shall update a PDU session in the V-SMF or I-SMF and/or provide information necessary for the V-SMF or I-SMF to send N1 SM signaling to the UE, or request to allocate or revoke EPS Bearer ID(s) for the PDU session, by using the HTTP “modify” custom operation as shown in FIG. 7d.
1. The NF Service Consumer shall send a POST request to the resource representing the individual PDU session resource in the V-SMF or I-SMF. The payload body of the POST request shall contain:
   the requestIndication IE indicating the request type, which is set to NW_REQ_PDU_SES_MOD;
   the modification instructions and/or the information necessary for the V-SMF or I-SMF to send N1 SM signalling to the UE;
   the hsmfPduSessionUri IE if the Update Request is sent to the V-SMF or I-SMF before the Create Response, and the H-SMF or SMF PDU session resource URI has not been previously provided to the V-SMF or I-SMF; in this case, the supportedFeatures IE shall also be included if at least one optional feature defined in clause 6.1.8 is supported.

If the PDU session may be moved to EPS with N26 and the EPS PDN Connection Context information of the PDU session is changed, e.g. due to a new anchor SMF is reselected, the payload shall include the “epsPdnCnxInfo” IE including the updated EPS PDN Connection Context information. The NF Service consumer shall overwrite the locally stored EPS PDN Connection Context information with the new one if received.

If the service operation is invoked after the reselection of the anchor SMF and the change of anchor SMF has not been signalled to the V-SMF or I-SMF previously, the request may carry the SMF Instance ID of the new anchor SMF and the updated PDU session resource URI in the HTTP payload body, and/or carry an updated binding indication in the HTTP headers to indicate the change of anchor SMF (as per step 6 of clause 6.5.3.3 of 3GPP TS 29.500 [4]).
2a. On success, “204 No Content” or “200 OK” shall be returned; in the latter case, the payload body of the POST response shall contain the representation describing the status of the request and/or information received by the V-SMF or I-SMF in N1 signalling from the UE.
2b. On failure or redirection, one of the HTTP status code listed in Table 6.1.3.7.4.2.2-1 shall be returned. For a 4xx/5xx response, the message body shall contain a VsmfUpdateError structure, including:
   a ProblemDetails structure with the “cause” attribute set to one of the application error listed in Table 6.1.3.7.4.2.2-1;
   the n1SmCause IE with the 5GSM cause returned by the UE, if available;
   n1SmInfoFromUe and/or unknownN1SmInfo binary data, if NAS SM information has been received from the UE that needs to be transferred to the H-SMF or SMF, or that the V-SMF or I-SMF does not comprehend;
   the procedure transaction id received from the UE, if available.

In an embodiment, clause 5.2.2.8.3.2 of 3GPP TS 29.502 V18.1.0 may be amended as following.

5.2.2.8.3.2 Network (e.g. H-SMF, SMF) Requested PDU Session Modification

The requirements specified in clause 5.2.2.8.3.1 shall apply with the following modifications.

1. Same as Step 1 of FIG. 7d, with the Following Modifications.

The requestIndication shall be set to NW_REQ_PDU_SES_MOD.

As part of the modification instructions, the NF Service Consumer may request to modify QoS parameters applicable at the PDU session level (e.g. modify the authorized Session AMBR values) or at the QoS flow level (e.g. modify the MFBR of a particular QoS flow).

The NF Service Consumer may request to establish, modify and/or release QoS flows by including the qosFlowsAddModRequestList IE and/or the qosFlowsRelRequestList IE in the payload body.

The H-SMF or SMF may provide alternative QoS profiles for each GBR QoS flow with Notification control enabled, to allow the NG-RAN to accept the setup of the QoS flow if the requested QoS parameters or at least one of the alternative QoS parameters sets can be fulfilled at the time of setup. If the H-SMF or SMF provides a new list of alternative QoS profile(s) for a given GBR Qos flow, the V-SMF or I-SMF shall replace any previously stored list for this Qos flow with it.

The NF Service Consumer may include epsBearerInfo IE(s), if the PDU session may be moved to EPS during its lifetime and the EPS Bearer(s) information has changed (e.g. a new EBI has been assigned or the mapped EPS bearer QoS for an existing EBI has changed).

The NF Service Consumer may include the modifiedEbiList IE if the PDU session modification procedure resulted in the change of ARP for a QoS flow that has already been allocated an EBI.

The NF Service Consumer may include the revokeEbiList IE to request the V-SMF or I-SMF to release some EBI(s) and delete any corresponding EPS bearer context stored in the V-SMF or I-SMF. The V-SMF or I-SMF shall disassociate the EBI(s) with the QFI(s) with which they are associated.

2. Same as Step 2 of FIG. 7d, with the Following Modifications.

The V-SMF or I-SMF may accept all or only a subset of the QoS flows requested to be created or modified within the request.

The list of QoS flows which have been successfully setup or modified, and those which failed to be so, if any, shall be included in the qosFlowsAddModList IE and/or the qosFlowsFailedtoAddModList IE respectively.

The V-SMF or I-SMF may report an alternative QoS profile which the NG-RAN currently fulfils in the currentQosProfileIndex IE of the corresponding Qos flow in the qosFlowsAddModList IE, or report that the NG-RAN cannot even fulfil the lowest alternative QoS profile by setting the nullQoSProfileIndex IE to “true” for the corresponding Qos flow in the qosFlowsAddModList IE.

If the NG-RAN rejects the establishment of a voice QoS flow due to EPS Fallback for IMS voice (see clause 4.13 of 3GPP TS 23.502 [3]), the V-SMF or I-SMF shall return the cause indicating that “mobility due to EPS fallback for IMS voice is on-going” for the corresponding flow in the qosFlowsFailedtoAddModList IE.

The list of QoS flows which have been successfully released, and those which failed to be so, if any, shall be included in the qosFlowsRelList and/or qosFlowsFailedtoRelList IE respectively.

For a QoS flow which failed to be modified, the V-SMF or I-SMF shall fall back to the configuration of the QoS flow as it was configured prior to the reception of the PDU session update request from the NF Service Consumer.

The V-SMF or I-SMF shall store any EPS bearer information received from the H-SMF or SMF. If the revokeEbiList IE is present in the request, the V-SMF or I-SMF shall request delete the corresponding EPS bearer contexts and request the AMF to release the EBIs listed in this IE. If the modifiedEbiList IE is present in the request, the V-SMF or I-SMF shall request the AMF to update the mapping of EBI and ARP if EAEA feature is supported by both AMF and V-SMF (or I-SMF), otherwise the V-SMF or I-SMF should indicate in the response that the modifiedEbiList is not delivered to the AMF.

If the request received from the H-SMF or SMF contains the alwaysOnGranted attribute set to true, the V-SMF or I-SMF shall check and determine whether the PDU session can be established as an always-on PDU session based on local policy.

In an embodiment, when the AMF and/or V-SMF (or I-SMF) does not support EAEA feature and/or the AMF cannot update the mapping of EBI and ARP, the response comprises first information indicating at least one of failure information, error information, the NF service producer cannot update the mapping of EBI and ARP, the modifiedEbiList is not delivered to the NF service producer, the modifiedEbiList is not updated to the NF service producer, the modifiedEbiList is not successfully handled by the NF service producer, or the AMF and/or V-SMF (or I-SMF) does not support EAEA feature.

In an embodiment, Table 6.1.6.2.16-1 of 3GPP TS 29.502 V18.1.0 may add the following content.

TABLE 6.1.6.2.16-1
Definition of type VsmfUpdatedData

| | | | | | |
|---|---|---|---|---|---|
| | | | Cardi- | | Applica- |
| Attribute name | Data type | P | nality | Description | bility |

| | | | | |
|---|---|---|---|---|
| modifiedEbiListNoDeliveryInd | boolean | C | 0 . . . 1 | This IE should be present with the value |
| | | | | “true” when the modifiedEbiList IE was |
| | | | | received in VsmfUpdateData in request |
| | | | | but cannot be updated to the AMF, e.g. |
| | | | | during (H-)SMF triggered PDU session |
| | | | | modification procedure and the AMF |
| | | | | doesn't support the EAEA feature). |
| | | | | When present, the IE shall be set as |
| | | | | following: |
| | | | | true: the received modifiedEbiList is not |
| | | | | updated to the AMF. |
| | | | | false: the received modifiedEbiList is |
| | | | | updated to the AMF. |

FIG. 7e shows a flowchart of method according to another embodiment of the present disclosure.

I-SMF/V-SMF may send indicate to SMF/H-SMF that modifiedEbiList is not successfully handled by AMF. It means that the SMF may retry later, or the I-SMF may cache the pending modified EBI/ARP mapping list and will provide to the AMF in a future SM Context Update response.
1. PCF may trigger ARP change for a current existing QoS flow. PCF may send Npcf_SMPolicyControl_UpdateNotify Request (PCC rules with different 5Q1) to PGW_C_SMF (i.e., PGW-C combined with SMF).
2. PGW_C_SMF may send Npcf_SMPolicyControl_UpdateNotify Response to PCF.
3. PGW_C_SMF may send Nsmf_PDUSession_Update Request (VsmfUpdateData) to I_SMF (i.e., I-SMF). PGW_C_SMF sends modifiedEbiList to I-SMF. If SMF finds it acts as an A-SMF/H-SMF now and SMF always support modifiedEbiList, when PCF changes ARP for the existing QoS flow, PGW_C_SMF may always send modifiedEbiList to I-SMF/V-SMF.
4. Namf_Communication_EBIAssignment operation may be performed between I_SMF and AMF.
5. I_SMF may send Nsmf_PDUSession_Update Response (VsmfUpdatedData) to PGW_C_SMF. If I-SMF/V-SMF knows that AMF doesn't handle modifiedEbiList successfully, I-SMF/V-SMF may send a failure indication to SMF/H-SMF in Nsmf_PDUSession_Update Response to SMF/H-SMF.
6. N4 Session Modification operation procedure (Setup service/QoS flow UL) may be performed between PGW_C_SMF and UPF.
7. PGW_C_SMF may send Nsmf_PDUSession_Update Request (VsmfUpdateData) to I_SMF.
8. Namf_Communication_N1N2MessageTransfer Request/Response (N1:PDU Session Modification Command, N2: PDU Session Resource Modify Request) may be exchanged between I_SMF and AMF.
9. AMF may send an N2 PDU Session Resource Modify Request to NG_RAN.
10. NG_RAN may send an N2 PDU Session Resource Modify Response to AMF.
11. AN specified resource modification operation may be performed between NG RAN and UE.
12. AMF may send an Nsmf_PDUSession_UpdateSMContext Request (e.g., N2:PDU Session resource Modify Resp) to I_SMF.
13. I_SMF may send Packet Forwarding Control Protocol (PFCP) Session Modification Request to I_UPF (i.e., intermediate UPF).
14. I_UPF may send PFCP Session Modification response to I_SMF.
15. I_SMF may send to AMF an Nsmf_PDUSession_UpdateSMContext Response.
16. Nsmf_PDUSession_UpdateSMContext service operation (N1: PDU Session Modification Complete) may be performed between AMF and I_SMF.
17. I_SMF may send Nsmf_PDUSession_Update_Response to PGW_C_SMF.

Some messages and operations of FIG. 7e may be same as the corresponding messages and operations as described in various 3GPP specifications such as 3GPP TS 29.502 V18.1.0, 3GPP TS 23.502 V18.0.0, 3GPP TS 29.518 V18.0.0, etc. Some messages (such as steps 3 and 5) of FIG. 7e are enhanced according to embodiments of the present disclosure.

FIG. 7f shows a flowchart of method according to another embodiment of the present disclosure.

Both I-SMF and A-SMF register with ServingArea and DTSSA (Deployments Topologies with specific SMF Service Areas) supportedFeature.
1a. UE may send to AMF a PDU Session Establishment Request.
1b. AMF may decide to insert I-SMF.
1c. AMF may send to I_SMF an Nsmf_PDUSession_CreateSMContext Request. AMF may add EAEA in supportedfeature of the Nsmf_PDUSession_CreateSMContext Request because SMF should know if AMF can accept modifiedEbiList if PCF changes ARP for the existing QoS flow.
2. I_SMF may send to AMF an Nsmf_PDUSession_CreateSMContext Response.
3. I_SMF may select I-UPF.
4. I_SMF may send to I_UPF a PFCP Session Establishment request.
5. I_UPF may send to I_SMF a PFCP Session Establishment response.
6. A-SMF may perform NRF AccessToken Get operation with NRF.
7. I_SMF may send to A_SMF an Nsmf_PDUSession_Create Request. EAEA may be added in supportedfeature of Nsmf_PDUSession_Create Request. EAEA may be added in supportedfeature between I-SMF/V-SMF and SMF/H-SMF.
8a. A_SMF may perform NRF Discovery for UDM SDM Service with NRF.
8b. A_SMF may perform Nudm_SDM_Get operation with UDM.
8c. A_SMF may perform Nudm_SDM_Subscribe operation with UDM.
9a. A_SMF may perform NRF Discovery for PCF with NRF.
9b. A_SMF may send to PCF an Npcf_SMPolicyControl_Create Request.
9c. PCF may send to A_SMF an Npcf_SMPolicyControl_Create Response.
10. A_SMF may send to I_SMF an Nsmf_PDUSession_Update Request (VsmfUpdateData).
11a. I_SMF may perform NRF Discovery for AMF Communication service with NRF.
11b. I_SMF may perform NRF AccessToken Get for AMF with NRF.
11c. I_SMF may send to AMF an Namf_comm_EBIAssignment Request.
11d. AMF may perform EBI revoke in case no EBI with A SMF.
11e. AMF may send to I_SMF an Namf_comm_EBIAssignment Response.
11f. I_SMF may send to A SMF an Nsmf_PDUSession_Update Response (VsmfUpdatedData.
12a. A SMF may send to CHF a Charging Data request.
12b. CHF may send to A_SMF a Charging Data response.
13. A_SMF may send to A_UPF a PFCP Session Establishment Request.
14. A_UPF may send to A SMF a PFCP Session Establishment Response.
15. NRF Discovery for UDM UECM Service may be performed between NRF and A_SMF.
16. Nudm_UECM_Registration operation may be performed between A_SMF and UDM.
17. A SMF may send to I_SMF an Nsmf_PDUSession_Create Response. SMF/H-SMF may negotiate EAEA in supportedfeature in PDUSessionCreateResponse to I-SMF/V-SMF.
18. N4 Session Modification may be performed between I_SMF and I_UPF.
20a. Namf_Communication_n1n2messageTransfer (N1 PDU Session Establishment Accept, N2 PDU Session Resource Setup Request transfer) may be performed between I_SMF and AMF. I-SMF/V-SMF sends the SMF/H-SMF supporting EAEA or not in the Namf_Communication_n1n2messageTransfer.
20b. Setup NGAP (Next Generation Application Protocol) Resource may be performed between RAN and AMF.
21. AMF may send to I_SMF an Nsmf_PDUSession_UpdateSMContext Request (N2 PDU Session Resource Setup Response Transfer);
22. PFCP Session Modification may be performed between I_SMF and I_UPF.
23. I_SMF may send to AMF an Nsmf_PDUSession_UpdateSMContext Response.

Some messages and operations of FIG. 7f may be same as the corresponding messages and operations as described in various 3GPP specifications such as 3GPP TS 29.502 V18.1.0, 3GPP TS 23.502 V18.0.0, 3GPP TS 29.518 V18.0.0, etc. Some messages (such as steps 1c, 7, 17 and 20a) of FIG. 7f are enhanced according to embodiments of the present disclosure.

In an embodiment, during UE requested PDU Session Establishment procedure for example described in clause 4.3.2.2 of 3GPP TS 23.502 V18.0.0, AMF and SMF may negotiate with EAEA in Namf_Communication_N1N2MessageTransfer service operation. For example, in step 11 of FIG. 4.3.2.2.1-1 of 3GPP TS 23.502 V18.0.0, AMF and SMF may negotiate with EAEA in supportedFeatures.

In an embodiment, during procedures for EPS bearer ID allocation for example described in clause 4.11.1.4 of 3GPP TS 23.502 V18.0.0, PCF may trigger ARP change for current existing QoS flow, the SMF may send modifiedEbiList to AMF if EAEA is supported with AMF for example in Namf_Communication_EBIAssignment Request (e.g., step 2 of FIG. 4.11.1.4.1-1 of 3GPP TS 23.502 V18.0.0), and the AMF may response with modifiedEbiList in Namf_Communication_EBIAssignment response (e.g., step 7 of FIG. 4.11.1.4.1-1 of 3GPP TS 23.502 V18.0.0) to SMF when the re-association is done.

Embodiments herein may provide many advantages, of which a non-exhaustive list of examples follows. In some embodiments herein, I-SMF/V-SMF can notify A-SMF/H-SMF/PGW-C+SMF if the modifiedEbiList is successful handled by AMF or not. In some embodiments herein, I-SMF/V-SMF can notify A-SMF/H-SMF/PGW-C+SMF if EAEA feature is supported or not. In some embodiments herein, it may ensure the consistence or alignment between SMF/H-SMF/PGW-C+SMF and AMF because SMF H-SMF/PGW-C+SMF can know whether AMF is updated or not. In some embodiments herein, it may avoid incorrect EBI assignment failure or revocation when EBIs are used out for a UE. The embodiments herein are not limited to the features and advantages mentioned above. A person skilled in the art will recognize additional features and advantages upon reading the following detailed description.

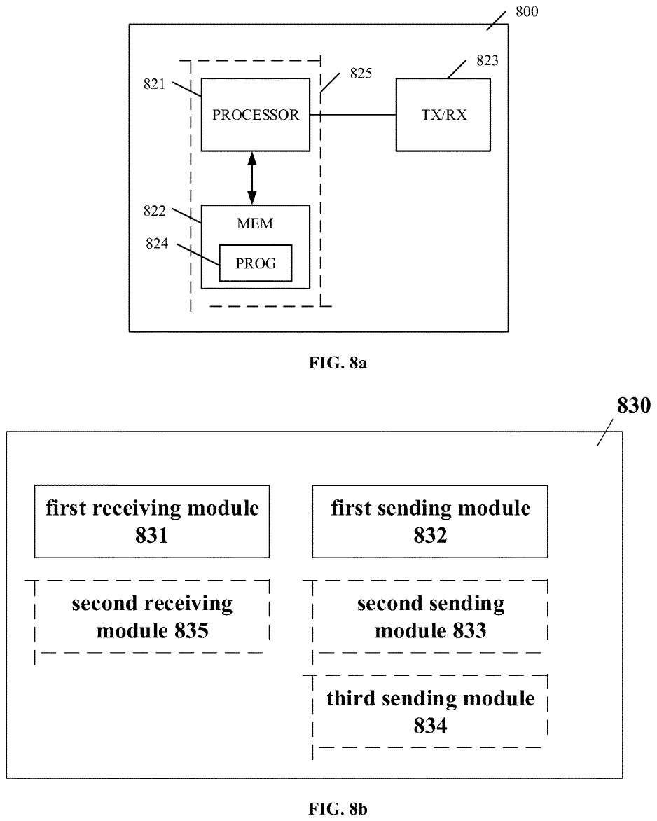

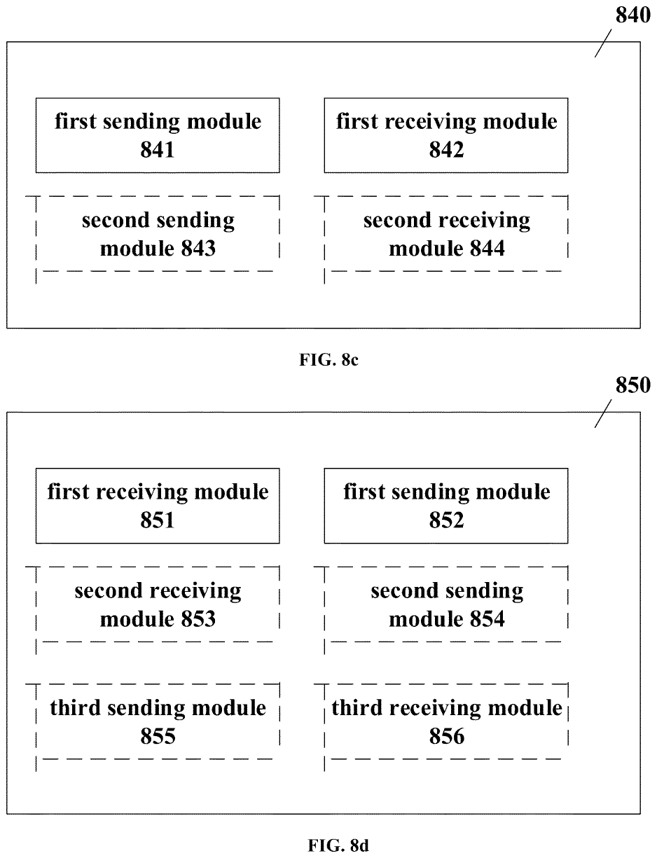

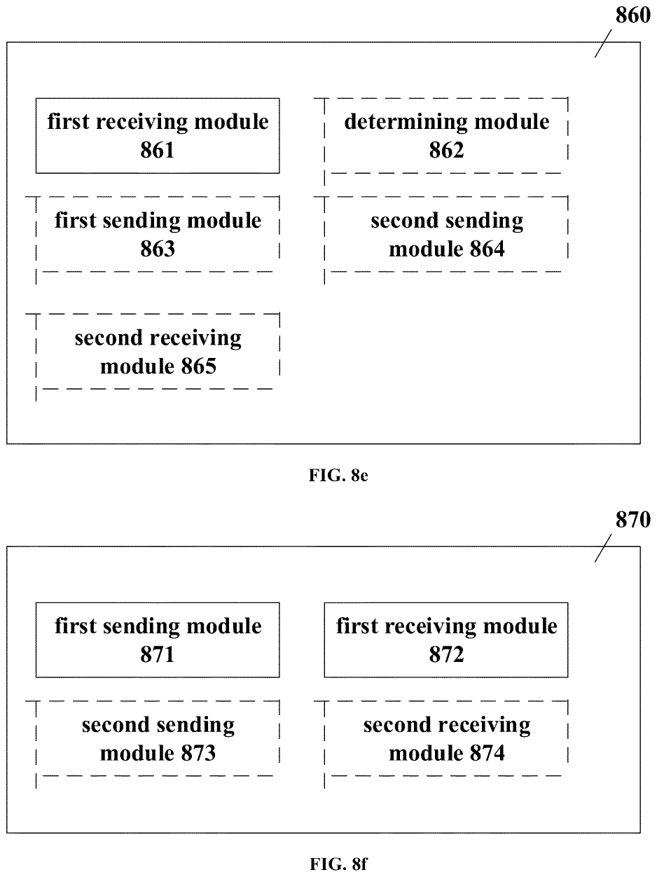

FIG. 8a is a block diagram showing an apparatus suitable for practicing some embodiments of the disclosure. For example, the first NF service consumer, the second NF service consumer, the third NF service consumer, the fourth NF service consumer or the NF service producer described above may be implemented as or through the apparatus 800.

The apparatus 800 comprises at least one processor 821, such as a digital processor (DP), and at least one memory (MEM) 822 coupled to the processor 821. The apparatus 800 may further comprise a transmitter TX and receiver RX 823 coupled to the processor 821. The MEM 822 stores a program (PROG) 824. The PROG 824 may include instructions that, when executed on the associated processor 821, enable the apparatus 800 to operate in accordance with the embodiments of the present disclosure. A combination of the at least one processor 821 and the at least one MEM 822 may form processing means 825 adapted to implement various embodiments of the present disclosure.

Various embodiments of the present disclosure may be implemented by computer program executable by one or more of the processor 821, software, firmware, hardware or in a combination thereof.

The MEM 822 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 821 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the first NF service consumer, the memory 822 contains instructions executable by the processor 821, whereby the first NF service consumer operates according to any of the methods related to the first NF service consumer as described above.

In an embodiment where the apparatus is implemented as or at the second NF service consumer, the memory 822 contains instructions executable by the processor 821, whereby the second NF service consumer operates according to any of the methods related to the second NF service consumer as described above.

In an embodiment where the apparatus is implemented as or at the third NF service consumer, the memory 822 contains instructions executable by the processor 821, whereby the third NF service consumer operates according to any of the methods related to the third NF service consumer as described above.

In an embodiment where the apparatus is implemented as or at the fourth NF service consumer, the memory 822 contains instructions executable by the processor 821, whereby the fourth NF service consumer operates according to any of the methods related to the fourth NF service consumer as described above.

In an embodiment where the apparatus is implemented as or at the NF service producer, the memory 822 contains instructions executable by the processor 821, whereby the NF service producer operates according to any of the methods related to the NF service producer as described above.

FIG. 8b is a block diagram showing a first NF service consumer according to an embodiment of the disclosure. As shown, the first NF service consumer 830 comprises a first receiving module 831 configured to receive a first request comprising modified evolved packet system bearer identity (EBI) list information element indicating one or more updated EBI and allocation and retention priority (ARP) mapping from a second NF service consumer. The first NF service consumer 830 further comprises a first sending module 832 configured to send a first response to the second NF service consumer. When the first NF service consumer and/or the NF service producer does not support EBI and ARP mapping update in EBI assignment and/or the NF service producer cannot update the mapping of EBI and ARP, the first response comprises first information indicating at least one of failure information, error information, the NF service producer cannot update the mapping of EBI and ARP, the modified EBI list information element is not delivered to the NF service producer, the modified EBI list information element is not updated to the NF service producer, the modified EBI list information element is not successfully handled by the NF service producer, or the first NF service consumer and/or the NF service producer does not support EBI and ARP mapping update in EBI assignment.

In an embodiment, the first NF service consumer 830 further comprises a second sending module 833 configured to, when both the first NF service consumer and the NF service producer support EBI and ARP mapping update in EBI assignment, send a second request comprising the modified EBI list information element to the NF service producer. The second request requests the NF service producer to update the mapping of EBI and ARP.

In an embodiment, the first NF service consumer 830 further comprises a third sending module 834 configured to, during fourth generation system to fifth generation system mobility procedure, send a message comprising information indicating whether the first NF service consumer supports EBI and ARP mapping update in EBI assignment to the second NF service consumer and/or the NF service producer.

In an embodiment, the first NF service consumer 830 further comprises a second receiving module 835 configured to, during fourth generation system to fifth generation system mobility procedure, receive a message comprising information indicating whether the second NF service consumer and/or the NF service producer supports EBI and ARP mapping update in EBI assignment from the second NF service consumer and/or the NF service producer.

FIG. 8c is a block diagram showing a second NF service consumer according to an embodiment of the disclosure. As shown, the second NF service consumer 840 comprises a first sending module 841 configured to send a first request comprising modified evolved packet system bearer identity (EBI) list information element indicating one or more updated EBI and allocation and retention priority (ARP) mapping to a first NF service consumer. The second NF service consumer 840 further comprises a first receiving module 842 configured to receiving a first response from the first NF service consumer. When the first NF service consumer and/or the NF service producer does not support EBI and ARP mapping update in EBI assignment and/or the NF service producer cannot update the mapping of EBI and ARP, the first response comprises first information indicating at least one of failure information, error information, the NF service producer cannot update the mapping of EBI and ARP, the modified EBI list information element is not delivered to the NF service producer, the modified EBI list information element is not updated to the NF service producer, the modified EBI list information element is not successfully handled by the NF service producer, or the first NF service consumer and/or the NF service producer does not support EBI and ARP mapping update in EBI assignment.

In an embodiment, the second NF service consumer 840 further comprises a second sending module 843 configured to, during fourth generation system to fifth generation system mobility procedure, send a message comprising information indicating whether the second NF service consumer supports EBI and ARP mapping update in EBI assignment to the first NF service consumer and/or the NF service producer.

In an embodiment, the second NF service consumer 840 further comprises a second receiving module 844 configured to, during fourth generation system to fifth generation system mobility procedure, receive a message comprising information indicating whether the first NF service consumer and/or the NF service producer supports EBI and ARP mapping update in EBI assignment from the first NF service consumer and/or the NF service producer.

FIG. 8d is a block diagram showing a third NF service consumer according to an embodiment of the disclosure. As shown, the third NF service consumer 850 comprises a first receiving module 851 configured to receive a first message from an NF service producer. The first message comprises information indicating whether the NF service producer supports evolved packet system bearer identity (EBI) and allocation and retention priority (ARP) mapping update in EBI assignment. The third NF service consumer 850 further comprises a first sending module 852 configured to send a second message to a fourth NF service consumer. The second message comprises information indicating whether the NF service producer and/or the third NF service consumer supports EBI and ARP mapping update in EBI assignment.

In an embodiment, the third NF service consumer 850 further comprises a second receiving module 853 configured to receive a third message from the fourth NF service consumer. The third message comprises information indicating whether the fourth NF service consumer supports EBI and ARP mapping update in EBI assignment.

In an embodiment, the third NF service consumer 850 further comprises a second sending module 854 configured to sending a fourth message to the NF service producer. The fourth message comprises information indicating whether the fourth NF service consumer and/or the third NF service consumer supports EBI and ARP mapping update in EBI assignment.

In an embodiment, the third NF service consumer 850 further comprises a third sending module 855 configured to, during fourth generation system to fifth generation system mobility procedure, send a message comprising information indicating whether the third NF service consumer supports EBI and ARP mapping update in EBI assignment to the fourth NF service consumer and/or the NF service producer.

In an embodiment, the third NF service consumer 850 further comprises a third receiving module 856 configured to, during fourth generation system to fifth generation system mobility procedure, receive a message comprising information indicating whether the fourth NF service consumer and/or the NF service producer supports EBI and ARP mapping update in EBI assignment from the fourth NF service consumer and/or the NF service producer.

FIG. 8e is a block diagram showing a fourth NF service consumer according to an embodiment of the disclosure. As shown, the fourth NF service consumer 860 comprises a first receiving module 861 configured to receive a second message from a third NF service consumer. The second message comprises information indicating whether an NF service producer and/or the third NF service consumer supports evolved packet system bearer identity (EBI) and allocation and retention priority (ARP) mapping update in EBI assignment.

In an embodiment, the fourth NF service consumer 860 further comprises a determining module 862 configured to determine whether to send a request comprising modified EBI list information element to the third NF service consumer based on the information. The request requests the NF service producer to update a mapping of EBI and ARP.

In an embodiment, the fourth NF service consumer 860 further comprises a first sending module 863 configured to send a third message to the third NF service consumer. The third message comprises information indicating whether the fourth NF service consumer supports EBI and ARP mapping update in EBI assignment.

In an embodiment, the fourth NF service consumer 860 further comprises a second sending module 864 configured to, during fourth generation system to fifth generation system mobility procedure, send a message comprising information indicating whether the fourth NF service consumer supports EBI and ARP mapping update in EBI assignment to the third NF service consumer and/or the NF service producer.

In an embodiment, the fourth NF service consumer 860 further comprises a second receiving module 865 configured to, during fourth generation system to fifth generation system mobility procedure, receive a message comprising information indicating whether the third NF service consumer and/or the NF service producer supports EBI and ARP mapping update in EBI assignment from the third NF service consumer and/or the NF service producer.

FIG. 8f is a block diagram showing a NF service producer according to an embodiment of the disclosure. As shown, the NF service producer 870 comprises a first sending module 871 configured to send a first message to a third NF service consumer. The first message comprises information indicating whether the NF service producer supports evolved packet system bearer identity (EBI) and allocation and retention priority (ARP) mapping update in EBI assignment. The information is to be sent to a fourth NF service consumer by the third NF service consumer.

In an embodiment, the NF service producer 870 further comprises a first receiving module 872 configured to receive a fourth message from the third NF service consumer. The fourth message comprises information indicating whether the fourth NF service consumer and/or the third NF service consumer supports EBI and ARP mapping update in EBI assignment.

In an embodiment, the NF service producer 870 further comprises a second sending module 873 configured to, during fourth generation system to fifth generation system mobility procedure, send a message comprising information indicating whether the NF service producer supports EBI and ARP mapping update in EBI assignment to the third NF service consumer and/or the fourth NF service consumer.

In an embodiment, the NF service producer 870 further comprises a second receiving module 874 configured to, during fourth generation system to fifth generation system mobility procedure, receive a message comprising information indicating whether the third NF service consumer and/or the fourth NF service consumer supports EBI and ARP mapping update in EBI assignment from the third NF service consumer and/or the fourth NF service consumer.

Further, the exemplary overall commutation system including the terminal device and the network node (such as the first NF service consumer, the second NF service consumer, the third NF service consumer, the fourth NF service consumer or the NF service producer) will be introduced as below.

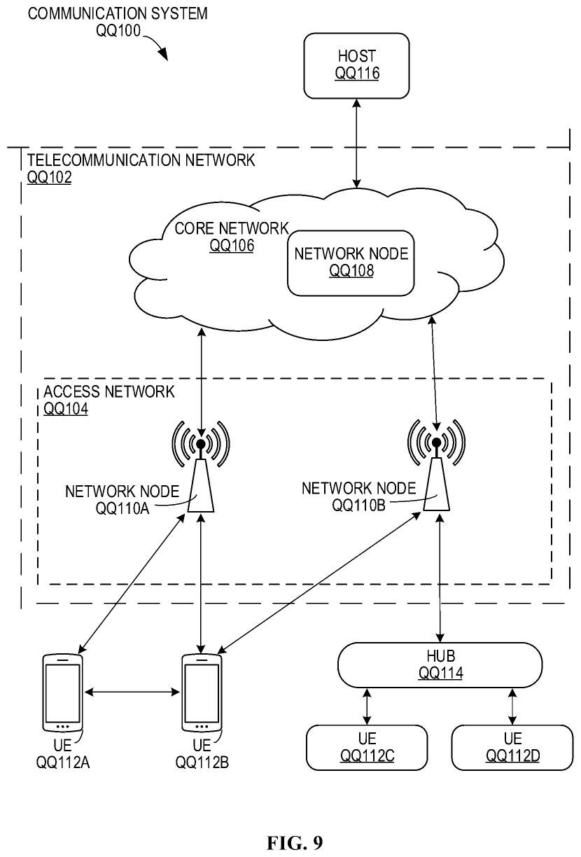

FIG. 9 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

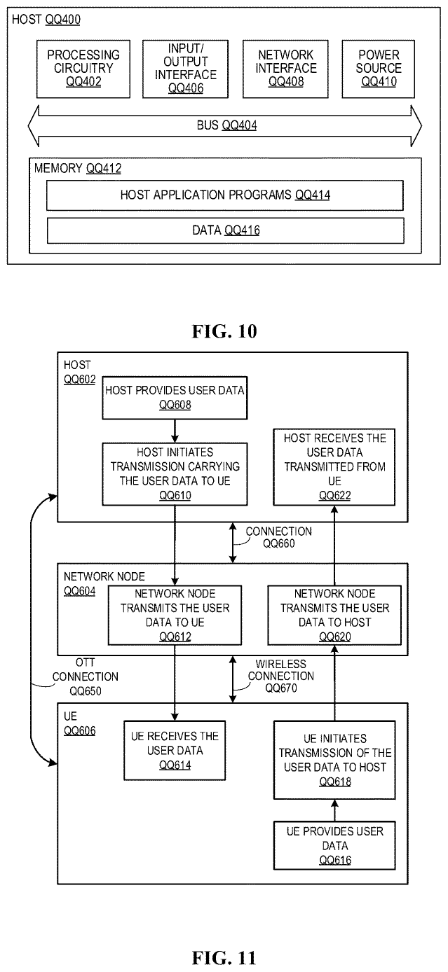

FIG. 10 is a block diagram of a host QQ400, which may be an embodiment of the host QQ116 of FIG. 9, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the terminal devices, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 9), network node (such as network node QQ110a of FIG. 9), and host (such as host QQ116 of FIG. 9 and/or host QQ400 of FIG. 10) discussed in the preceding paragraphs will now be described with reference to FIG. 11.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 9) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, in some embodiments herein, I-SMF/V-SMF can notify A-SMF/H-SMF/PGW-C+SMF if the modifiedEbiList is successful handled by AMF or not. In some embodiments herein, I-SMF/V-SMF can notify A-SMF/H-SMF/PGW-C+SMF if EAEA feature is supported or not. In some embodiments herein, it may ensure the consistence or alignment between SMF/H-SMF/PGW-C+SMF and AMF because SMF H-SMF/PGW-C+SMF can know whether AMF is updated or not. In some embodiments herein, it may avoid incorrect EBI assignment failure or revocation when EBIs are used out for a UE.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Embodiment 1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the operations related to the network node as described above to transmit the user data from the host to the UE.

Embodiment 2. The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the operations related to the network node as described above to transmit the user data from the host to the UE.

Embodiment 4. The method of the previous embodiment, further comprising, at the network node, transmitting the user data provided by the host for the UE.

Embodiment 5. The method of any of the previous 2 embodiments, wherein the user data is provided at the host by executing a host application that interacts with a client application executing on the UE, the client application being associated with the host application.

Embodiment 6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the operations related to the network node as described above to transmit the user data from the host to the UE.

Embodiment 7. The communication system of the previous embodiment, further comprising:
the network node; and/or
the user equipment.

Embodiment 8. The communication system of the previous 2 embodiments, wherein:
the processing circuitry of the host is configured to execute a host application, thereby providing the user data; and
the host application is configured to interact with a client application executing on the UE, the client application being associated with the host application.

Embodiment 9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform the operations related to the network node as described above to receive the user data from the UE for the host.

Embodiment 10. The host of the previous 2 embodiments, wherein:
the processing circuitry of the host is configured to execute a host application, thereby providing the user data; and
the host application is configured to interact with a client application executing on the UE, the client application being associated with the host application.

Embodiment 11. The host of they of the previous 2 embodiments, wherein the initiating receipt of the user data comprises requesting the user data.

Embodiment 12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the operations related to the network node as described above to receive the user data from the UE for the host.

Embodiment 13. The method of the previous embodiment, further comprising at the network node, transmitting the received user data to the host.

Embodiment 14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform the operations related to the UE as described above to receive the user data from the host.

Embodiment 15. The host of the previous embodiment, wherein the cellular network further includes a network node configured to communicate with the UE to transmit the user data to the UE from the host.

Embodiment 16. The host of the previous 2 embodiments, wherein:
the processing circuitry of the host is configured to execute a host application, thereby providing the user data; and
the host application is configured to interact with a client application executing on the UE, the client application being associated with the host application.

Embodiment 17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs the operations related to the UE as described above to receive the user data from the host.

Embodiment 18. The method of the previous embodiment, further comprising:
at the host, executing a host application associated with a client application executing on the UE to receive the user data from the UE.

Embodiment 19. The method of the previous embodiment, further comprising:
at the host, transmitting input data to the client application executing on the UE, the input data being provided by executing the host application,
wherein the user data is provided by the client application in response to the input data from the host application.

Embodiment 20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform the operations related to the UE as described above to transmit the user data to the host.

Embodiment 21. The host of the previous embodiment, wherein the cellular network further includes a network node configured to communicate with the UE to transmit the user data from the UE to the host.

Embodiment 22. The host of the previous 2 embodiments, wherein:
the processing circuitry of the host is configured to execute a host application, thereby providing the user data; and
the host application is configured to interact with a client application executing on the UE, the client application being associated with the host application.

Embodiment 23. A method implemented by a host configured to operate in a communication system that further includes a network node and a user equipment (UE), the method comprising:
at the host, receiving user data transmitted to the host via the network node by the UE, wherein the UE performs the operations related to the UE as described above to transmit the user data to the host.

Embodiment 24. The method of the previous embodiment, further comprising:
at the host, executing a host application associated with a client application executing on the UE to receive the user data from the UE.

Embodiment 25. The method of the previous embodiments, further comprising:
at the host, transmitting input data to the client application executing on the UE, the input data being provided by executing the host application,
wherein the user data is provided by the client application in response to the input data from the host application.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the first NF service consumer, the second NF service consumer, the third NF service consumer, the fourth NF service consumer or the NF service producer may not need a fixed processor or memory, any computing resource and storage resource may be arranged from the first NF service consumer, the second NF service consumer, the third NF service consumer, the fourth NF service consumer or the NF service producer in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform one or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-69. (canceled)

70. A method performed by a first network function (NF) service consumer, comprising:
receiving a first request comprising modified evolved packet system bearer identity (EBI) list information element indicating one or more updated EBI and allocation and retention priority (ARP) mapping from a second NF service consumer;
sending a first response to the second NF service consumer; and
when one or both of:
one or both of the first NF service consumer and an NF service producer do not support EBI and ARP mapping update in EBI assignment; and
the NF service producer cannot update the mapping of EBI and ARP, then
the first response comprises first information indicating at least one of:
failure information;
the NF service producer cannot update the mapping of EBI and ARP;
the modified EBI list information element is not delivered to the NF service producer;
the modified EBI list information element is not updated to the NF service producer;
the modified EBI list information element is not successfully handled by the NF service producer; or
one or both of the first NF service consumer and the NF service producer do not support EBI and ARP mapping update in EBI assignment.

71. The method according to claim 70, wherein one or more of:
the first request is a protocol data unit (PDU) session update request and the first response is a PDU session update response;
the first information is comprised in visited session management function (SMF) updated data; and
a data type of the first information is Boolean and the first information is set as true.

72. The method according to claim 70, further comprising:
when both the first NF service consumer and the NF service producer support EBI and ARP mapping update in EBI assignment, sending a second request comprising the modified EBI list information element to the NF service producer, wherein the second request requests the NF service producer to update the mapping of EBI and ARP.

73. The method according to claim 70, wherein one or both:
when both the first NF service consumer and the NF service producer support EBI and ARP mapping update in EBI assignment; and
the NF service producer has updated the mapping of EBI and ARP,
then the first response comprises second information indicating at least one of:
successful information;
the NF service producer has updated the mapping of EBI and ARP;
the modified EBI list information element is delivered to the NF service producer;
the modified EBI list information element is updated to the NF service producer;
the modified EBI list information element is successfully handled by the NF service producer; or
the first NF service consumer and the NF service producer support EBI and ARP mapping update in EBI assignment.

74. The method according to claim 73, wherein one or more of:
the second information is comprised in visited SMF updated data;
a data type of the second information is Boolean and the second information is set as false; and
the second request is an EBI assignment request.

75. The method according to claim 70, wherein one or more of:
the first NF service consumer comprises at least one of:
an intermediate SMF; or
a visited SMF;
the second NF service consumer comprises at least one of:
an SMF;
a Packet Data Network Gateway control plane (PGW-C) combined with SMF; or
a home SMF; and
the NF service producer comprises an access and mobility management function (AMF).

76. The method according to claim 70, further comprising one or both:
during fourth generation system to fifth generation system mobility procedure, sending a message comprising information indicating whether the first NF service consumer supports EBI and ARP mapping update in EBI assignment to one or both of the second NF service consumer and the NF service producer; and
during fourth generation system to fifth generation system mobility procedure, receiving a message comprising information indicating whether the one or both of the second NF service consumer and the NF service producer supports EBI and ARP mapping update in EBI assignment from the second NF service consumer and/or the NF service producer.

77. A method performed by a second network function (NF) service consumer, the method comprising:
sending a first request comprising modified evolved packet system bearer identity (EBI) list information element indicating one or more updated EBI and allocation and retention priority (ARP) mapping to a first NF service consumer;
receiving a first response from the first NF service consumer; and
when one or both of:
one or both of the first NF service consumer and an NF service producer do not support EBI and ARP mapping update in EBI assignment; and
the NF service producer cannot update the mapping of EBI and ARP, then
the first response comprises first information indicating at least one of:
failure information;
the NF service producer cannot update the mapping of EBI and ARP;
the modified EBI list information element is not delivered to the NF service producer;
the modified EBI list information element is not updated to the NF service producer;
the modified EBI list information element is not successfully handled by the NF service producer; or
one or both of the first NF service consumer and the NF service producer do not support EBI and ARP mapping update in EBI assignment.

78. The method according to claim 77, wherein one or more of:
the first request is a protocol data unit (PDU) session update request and the first response is a PDU session update response;
the first information is comprised in visited session management function (SMF) updated data; and
a data type of the first information is Boolean and the first information is set as true.

79. The method according to claim 77, wherein one or both:
when both the first NF service consumer and the NF service producer support EBI and ARP mapping update in EBI assignment; and
the NF service producer has updated the mapping of EBI and ARP,
then the first response comprises second information indicating at least one of:
successful information;
the NF service producer has updated the mapping of EBI and ARP;
the modified EBI list information element is delivered to the NF service producer;
the modified EBI list information element is updated to the NF service producer;
the modified EBI list information element is successfully handled by the NF service producer; or
the first NF service consumer and the NF service producer support EBI and ARP mapping update in EBI assignment.

80. The method according to claim 79, wherein one or both:
the second information is comprised in visited SMF updated data; and
a data type of the second information is Boolean and the second information is set as false.

81. The method according to claim 77, wherein one or more of:
the first NF service consumer comprises at least one of:
an intermediate SMF; or
a visited SMF;
the second NF service consumer comprises at least one of:
an SMF;
a Packet Data Network Gateway control plane (PGW-C) combined with SMF; or
a home SMF; and
the NF service producer comprises an access and mobility management function (AMF).

82. The method according to claim 77, wherein one or both:
the first request is sent to the first NF service consumer when an ARP for a quality of service (QoS) flow that has already been allocated an EBI is changed; and
the second NF service consumer does not know whether the first NF service consumer and/or the NF service producer supports EBI and ARP mapping update in EBI assignment.

83. The method according to claim 77, further comprising one or both:
during fourth generation system to fifth generation system mobility procedure, sending a message comprising information indicating whether the second NF service consumer supports EBI and ARP mapping update in EBI assignment to one or both of the first NF service consumer and the NF service producer; and
during fourth generation system to fifth generation system mobility procedure, receiving a message comprising information indicating whether one or both of the first NF service consumer and the NF service producer supports EBI and ARP mapping update in EBI assignment from the first NF service consumer and/or the NF service producer.

84. A first network function (NF) service consumer, comprising:
a processor; and
a memory coupled to the processor, the memory containing instructions executable by the processor, to configure the first NF service consumer to:
receive a first request comprising modified evolved packet system bearer identity (EBI) list information element indicating one or more updated EBI and allocation and retention priority (ARP) mapping from a second NF service consumer;
send a first response to the second NF service consumer; and
when one or both of:
one or both of the first NF service consumer and an NF service producer do not support EBI and ARP mapping update in EBI assignment; and
the NF service producer cannot update the mapping of EBI and ARP, then
the first response comprises first information indicating at least one of:
failure information;
the NF service producer cannot update the mapping of EBI and ARP;
the modified EBI list information element is not delivered to the NF service producer;
the modified EBI list information element is not updated to the NF service producer;
the modified EBI list information element is not successfully handled by the NF service producer; or
one or both of the first NF service consumer and the NF service producer do not support EBI and ARP mapping update in EBI assignment.

85. The first NF service consumer according to claim 84, wherein one or more of:
the first request is a protocol data unit (PDU) session update request and the first response is a PDU session update response;
the first information is comprised in visited session management function (SMF) updated data; and
a data type of the first information is Boolean and the first information is set as true.

86. The first NF service consumer according to claim 84, wherein one or both:
when both the first NF service consumer and the NF service producer support EBI and ARP mapping update in EBI assignment, the first NF service consumer is further configured to send a second request comprising the modified EBI list information element to the NF service producer, wherein the second request requests the NF service producer to update the mapping of EBI and ARP; and
when one or both:
both the first NF service consumer and the NF service producer support EBI and ARP mapping update in EBI assignment; and
the NF service producer has updated the mapping of EBI and ARP, then the first response comprises second information indicating at least one of:
successful information;
the NF service producer has updated the mapping of EBI and ARP;
the modified EBI list information element is delivered to the NF service producer;
the modified EBI list information element is updated to the NF service producer;
the modified EBI list information element is successfully handled by the NF service producer; or
the first NF service consumer and the NF service producer support EBI and ARP mapping update in EBI assignment.

87. A second network function (NF) service consumer, comprising:
a processor; and
a memory coupled to the processor, the memory containing instructions executable by the processor, to configure the second NF service to:
send a first request comprising modified evolved packet system bearer identity (EBI) list information element indicating one or more updated EBI and allocation and retention priority (ARP) mapping to a first NF service consumer;
receive a first response from the first NF service consumer; and
when one or both of:
one or both of the first NF service consumer and an NF service producer do not support EBI and ARP mapping update in EBI assignment; and
the NF service producer cannot update the mapping of EBI and ARP, then
the first response comprises first information indicating at least one of:
failure information;
the NF service producer cannot update the mapping of EBI and ARP;
the modified EBI list information element is not delivered to the NF service producer;
the modified EBI list information element is not updated to the NF service producer;
the modified EBI list information element is not successfully handled by the NF service producer; or
one or both of the first NF service consumer and the NF service producer do not support EBI and ARP mapping update in EBI assignment.

88. The second NF service consumer according to claim 87, wherein one or more of:
the first request is a PDU session update request and the first response is a PDU session update response;
the first information is comprised in visited SMF updated data; and
a data type of the first information is Boolean and the first information is set as true.

89. The second NF service consumer according to claim 87, wherein one or both:
when both the first NF service consumer and the NF service producer support EBI and ARP mapping update in EBI assignment; and
the NF service producer has updated the mapping of EBI and ARP, then
the first response comprises second information indicating at least one of:
successful information;
the NF service producer has updated the mapping of EBI and ARP,
the modified EBI list information element is delivered to the NF service producer;
the modified EBI list information element is updated to the NF service producer;
the modified EBI list information element is successfully handled by the NF service producer; or
the first NF service consumer and the NF service producer support EBI and ARP mapping update in EBI assignment.
